(19) United States
(12) Patent Application Publication
(10) Pub. No.: US 2026/0023395 A1
(43) Pub. Date: Jan. 22, 2026

(54) SYSTEM, METHOD, AND COMPUTER READABLE MEDIUM FOR AFFINE FORMATION MANEUVERING OF NONLINEAR MULTI-AGENT SYSTEMS WITH FAULT-TOLERANT SECURE OPTIMIZED BACKSTEPPING CONTROL USING REINFORCEMENT LEARNING

(71) Applicant: KING FAHD UNIVERSITY OF PETROLEUM AND MINERALS, Dhahran (SA)

(72) Inventors: Muhammad MAARUF, Dhahran (SA); Sami EL FERIK, Dhahran (SA)

(73) Assignee: KING FAHD UNIVERSITY OF PETROLEUM AND MINERALS, Dhahran (SA)

(21) Appl. No.: 19/015,498

(22) Filed: Jan. 9, 2025

Related U.S. Application Data
(60) Provisional application No. 63/673,500, filed on Jul. 19, 2024.

(51) Int. Cl. G05D 1/695; G05B 13/02; G05D 1/226; G05D 1/85; G05D 1/86; G05D 101/15

(52) U.S. Cl. CPC G05D 1/695; G05B 13/027; G05D 1/226; G05D 1/854; G05D 1/857; G05D 1/86; G05D 2101/15

(57) ABSTRACT

A system, computer readable storage medium and method for controlling a trajectory of coordinated time-varying maneuvers of a geometric formation of unmanned vehicles is disclosed. The system includes unmanned vehicles, each configured with communication circuitry to communicate between the vehicles. A subset of the unmanned vehicles function as leader vehicles, with the remaining vehicles functioning as follower vehicles for leader-follower maneuvering. The system further includes an actuator suite configured to adjust the direction and orientation of each vehicle, a sensor suite for stabilization and navigation, and a flight controller for maintaining stable maneuvering, even in the presence of actuator faults and sensor deception attacks. Processing circuitry is configured with a reinforcement learning neural network that includes identifier, actor, and critic radial basis function neural networks to estimate movement, adjust control actions, and assess vehicle performance based on feedback signals, including corrupted signals from the sensor suite due to deception attacks.

### CROSS-REFERENCE TO RELATED APPLICATIONS

This application claims the benefit of priority to provisional application No. 63/673,500 filed Jul. 19, 2024, the entire contents of which are incorporated herein by reference.

### STATEMENT OF ACKNOWLEDGEMENT

The authors would like to acknowledge the support provided by the Deanship of Scientific Research (DSR) at King Fahd University of Petroleum & Minerals (KFUPM), Dhahran, Saudi Arabia, for this work.

### BACKGROUND

### Technical Field

The present disclosure is directed to control of affine formation maneuvers for nonlinear multi-agent systems, more specifically to a system and method for affine formation maneuvering of nonlinear multi-agent systems with fault-tolerant secure optimized backstepping control using reinforcement learning.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Multi-agent systems have been extensively explored for a variety of applications, particularly in the guidance and navigation of autonomous vehicles. Formation control of these systems enables multiple agents to establish a predefined geometric formation, which has applications in cooperative robotics, autonomous transport, and drone swarms. A more sophisticated aspect, termed formation maneuver control, focuses on altering the formation in terms of shape, scaling, rotation, and other transformations to meet dynamic mission requirements.

Formation maneuver control approaches may partition agents into leaders and followers. Leaders dictate the formation's maneuver, such as its translation, rotation, or scaling, while followers track the leaders to maintain the intended formation. Generally, formation control can be categorized into bearing-based, relative position-based, and distance-based control methods. Each of these methods offers specific advantages, for example, bearing-based control facilitates translation and scaling, relative position-based control is suitable for tracking time-varying translations, and distance-based control is apt for scenarios involving rotational and translational maneuvers. However, each approach has distinct limitations, such as difficulty in achieving rotation, scaling, or general maneuvers simultaneously.

Some advancements have included the use of complex Laplacian matrix-based formation maneuver controls, where complex weights are assigned to matrix edges to achieve different maneuvers. Additionally, affine formation maneuver control has been explored to offer a broader range of maneuvers, including rotation, scaling, shearing, and collinearity. This approach uses affine transformations and stress matrices, and it is particularly versatile as it allows both positive and negative weights. Various algorithms have been developed to extend affine formation maneuver control to different agent dynamics, including single-integrator, double-integrator, and even high-order systems subject to time-varying delays or external disturbances.

Wireless communication among agents provides an effective solution for coordinating multi-agent systems, making them efficient in terms of cost and scalability. However, it also exposes these systems to cyber-attacks such as deception attacks and denial of service (DOS) attacks. These attacks can inject malicious signals, disrupt communication, and destabilize the entire formation, rendering conventional control approaches ineffective.

Another challenge arises from faults in the actuators of the mobile agents. These faults can impair the functionality of an individual agent and even propagate across the entire formation, compromising the intended control performance. To mitigate such issues, fault-tolerant control methods have been explored to ensure the overall stability and robustness of the formation despite individual agent faults.

Despite these advancements, the aforementioned approaches face significant challenges in practical implementations. The presence of dynamic environments, actuator faults, and cyber-attacks requires control approaches that are robust and adaptable to disturbances. Handling deception attacks and addressing fault-tolerant affine formation maneuver control for nonlinear systems is required. Moreover, current approaches lack effective prescribed performance functions to ensure that formation tracking errors remain confined within a predefined acceptable region, especially in the presence of actuator faults and attacks.

Therefore, there is a need for a resilient formation maneuver control system capable of addressing cyber-attacks, particularly deception attacks, and actuator faults while maintaining prescribed performance standards. An aspect is a system that enhances the robustness and reliability of affine formation maneuvering for nonlinear multi-agent systems, offering an adaptable solution for dynamic environments.

### SUMMARY

In an exemplary embodiment, a system for controlling a trajectory of coordinated time-varying maneuvers of a geometric formation of unmanned vehicles comprises a plurality of the unmanned vehicles, each having communication circuitry configured to communicate between each unmanned vehicle of the plurality of unmanned vehicles. A subset of the plurality of the unmanned vehicles are leader vehicles, and the remaining unmanned vehicles are follower vehicles, for leader-follower maneuvering of the geometric formation of the plurality of unmanned vehicles to target positions of the trajectory. An actuator suite is configured to maintain and adjust the direction and orientation of a respective unmanned vehicle. A sensor suite is configured to stabilize and navigate the respective unmanned vehicle. A flight controller is configured to send a control signal to the actuator suite and receive a feedback signal from the sensor suite. The flight controller maintains stable maneuvering of the respective unmanned vehicle while the actuator suite is subject to an actuator fault and the sensor suite is subject to a deception attack. Processing circuitry is configured to control the leader-follower maneuvering of the geometric formation of the plurality of unmanned vehicles. The maneuvering of the plurality of unmanned vehicles is controlled with a reinforcement learning neural network that includes an identifier radial basis function neural network to estimate nonlinear movement of the plurality of unmanned vehicles. An actor radial basis function neural network is configured to adjust the direction and orientation of the respective unmanned vehicle by the respective actuator suite based on the estimated nonlinear movement. A critic radial basis function neural network is configured to assess the adjusted direction and orientation of each of the unmanned vehicles based on a feedback signal from the sensor suite. The feedback signal includes corrupted signals from the sensor suite due to the deception attack.

In another exemplary embodiment, a non-transitory computer-readable storage medium including computer executable instructions, wherein the instructions, when executed by a computer, cause the computer to perform a method for controlling a trajectory of coordinated time-varying maneuvers of a geometric formation of unmanned vehicles, the method comprising controlling a leader-follower maneuvering of the geometric formation of a plurality of unmanned vehicles with a reinforcement learning neural network. A subset of the unmanned vehicles are leader vehicles, and the remaining unmanned vehicles are follower vehicles, for the leader-follower maneuvering of the geometric formation of the plurality of unmanned vehicles to target positions of a trajectory. The method further comprises estimating, by an identifier radial basis function neural network, nonlinear movement of the plurality of unmanned vehicles, adjusting, by an actor radial basis function neural network, the direction and orientation of the respective unmanned vehicle by actions that control a respective actuator suite based on the estimated nonlinear movement. The actuator suite is subject to an actuator fault. The method further comprises assessing, by a critic radial basis function neural network, the adjusted direction and orientation of each of the unmanned vehicles based on a feedback signal from a sensor suite. The feedback signal includes corrupted signals from the sensor suite due to a deception attack.

In another exemplary embodiment, a method for controlling a trajectory of coordinated time-varying maneuvers of a geometric formation of unmanned vehicles comprising controlling a leader-follower maneuvering of the geometric formation of a plurality of unmanned vehicles with a reinforcement learning neural network. A subset of the unmanned vehicles are leader vehicles and the remaining unmanned vehicles are follower vehicles, for the leader-follower maneuvering of the geometric formation of the plurality of unmanned vehicles to target positions of a trajectory. The method further comprises estimating, by an identifier radial basis function neural network, nonlinear movement of the plurality of unmanned vehicles, adjusting, by an actor radial basis function neural network, the direction and orientation of the respective unmanned vehicle by actions that control a respective actuator suite based on the estimated nonlinear movement. The actuator suite is subject to an actuator fault. The method further comprises assessing, by a critic radial basis function neural network, the adjusted direction and orientation of each of the unmanned vehicles based on a feedback signal from a sensor suite. The feedback signal includes corrupted signals from the sensor suite due to a deception attack.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an unmanned vehicle system, in accordance with an exemplary aspect of the disclosure;

FIG. 1B illustrates an unmanned vehicle system configured to control the trajectory of coordinated time-varying maneuvers of a geometric formation of unmanned vehicles, in accordance with an exemplary aspect of the disclosure;

FIG. 2A illustrates a quad-rotor autonomous aerial vehicle, in accordance with an exemplary aspect of the disclosure;

FIG. 2B illustrates a single rotor unmanned aerial vehicle, in accordance with the exemplary aspect of the disclosure;

FIG. 3A depicts the behavior of the tracking error over time when a sudden change in the target trajectory occurs at t=4 seconds and t=8 seconds, in accordance with the exemplary aspect of the disclosure;

FIG. 3B depicts the state trajectory pᵢ tracking the target trajectory pⁱ′ as sudden changes in amplitude occurs at t=4 seconds and t=8 seconds, in accordance with the exemplary aspect of the disclosure;

FIG. 4A depicts the behavior of the tracking error εᵢ under a sudden change in the target trajectory at t=4 seconds, in accordance with the exemplary aspect of the disclosure;

FIG. 4B depicts the state trajectory pᵢ tracking the target trajectory pᵢ′ when sudden changes in amplitude occur at t=4 seconds, in accordance with the exemplary aspect of the disclosure;

FIG. 5 illustrates the leader-follower nominal formation topology for a multi-agent system, in accordance with the exemplary aspect of the disclosure;

FIG. 6A depicts the behavior of the optimized virtual controllers of leaders and followers of UAV formation in x-axis, in accordance with the exemplary aspect of the disclosure;

FIG. 6B depicts the behavior of the optimized virtual controllers the of leaders and followers of UAV formation in y-axis, in accordance with the exemplary aspect of the disclosure;

FIG. 7A depicts the behavior of the control inputs the of leaders and followers of UAV formation in the x-axis, in accordance with the exemplary aspect of the disclosure;

FIG. 7B depicts the behavior of the control inputs the of leaders and followers of UAV formation in the y-axis, in accordance with the exemplary aspect of the disclosure;

FIG. 8A illustrates time-varying trajectories the of leaders and followers of UAV formation in the x-axis, in accordance with the exemplary aspect of the disclosure;

FIG. 8B illustrates time-varying trajectories the of leaders and followers of UAV formation in the y-axis, in accordance with the exemplary aspect of the disclosure;

FIG. 9A illustrates tracking errors of the of leaders and followers of UAV formation in the x-axis over time in accordance with the exemplary aspect of the disclosure;

FIG. 9B illustrates tracking errors of the of leaders and followers of UAV formation in the y-axis over time, in accordance with the exemplary aspect of the disclosure;

FIG. 10 illustrates the affine formation maneuvers of the leader-follower system under adversarial conditions, in accordance with the exemplary aspect of the disclosure;

FIG. 11A presents the time-varying trajectories of the leaders and followers of UAV formation in the x-axis, in accordance with the exemplary aspect of the disclosure;

FIG. 11B presents the time-varying trajectories of the leaders and followers of UAV formation in the y-axis, in accordance with the exemplary aspect of the disclosure;

FIG. 12 illustrates the affine formation maneuvers of the leader-follower system with another existing control method, in accordance with the exemplary aspect of the disclosure;

FIG. 13 is an illustration of a non-limiting example of details of mobile computing hardware used in the computing system, according to certain embodiments; and

FIG. 14 is an illustration of a non-limiting example of details of computer system for implementing the machine learning training and inference methods used in the computing system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a system and method for affine formation maneuver control of nonlinear multi-agent systems, focusing particularly on resilience against actuator faults and deception attacks while maintaining prescribed performance during leader-follower maneuvers. Known formation maneuver control methods for multi-agent systems are limited by their inability to effectively address security threats such as deception attacks and physical faults in actuators, which significantly affect the stability and performance of the overall system.

For purposes of this disclosure, a multi-agent system can include an unmanned vehicle, particularly an unmanned aerial vehicle (UAV), as well as fleet vehicles that move in a coordinated fashion. The unmanned vehicle is not limited to an aerial vehicle, but can be an unmanned vehicle that travels under water, or in outer space, in a coordinated fashion. Also, the unmanned vehicles can include a combination of different types of unmanned vehicles, only limited by a capability to communicate with each other and perform manoeuvring operations using an embedded control mechanism. Hereinafter, multi-agent systems will be referred to as unmanned vehicles.

The present disclosure provides a system for controlling the trajectory of coordinated, time-varying maneuvers of a geometric formation of unmanned vehicles. The system comprises multiple unmanned vehicles, including at least one leader vehicle and follower vehicles, wherein each unmanned vehicle is equipped with communication circuitry, an actuator suite, a sensor suite, a flight controller, and processing circuitry. The leader vehicles define the trajectory, while the follower vehicles track the leader to maintain the desired geometric formation. The flight controller is configured to maintain stable maneuvering, even when the actuator suite is subjected to faults and the sensor suite experiences a deception attack.

The system includes a reinforcement learning framework configured to estimate the nonlinear movement of the unmanned vehicles, adjust the movement based on the estimated dynamics, and evaluate the adjusted movement based on feedback from the sensor suite, which may include corrupted signals due to deception attacks. By implementing the reinforcement learning framework, the system dynamically adapts to disturbances, ensuring stable formation maneuvers under adverse conditions.

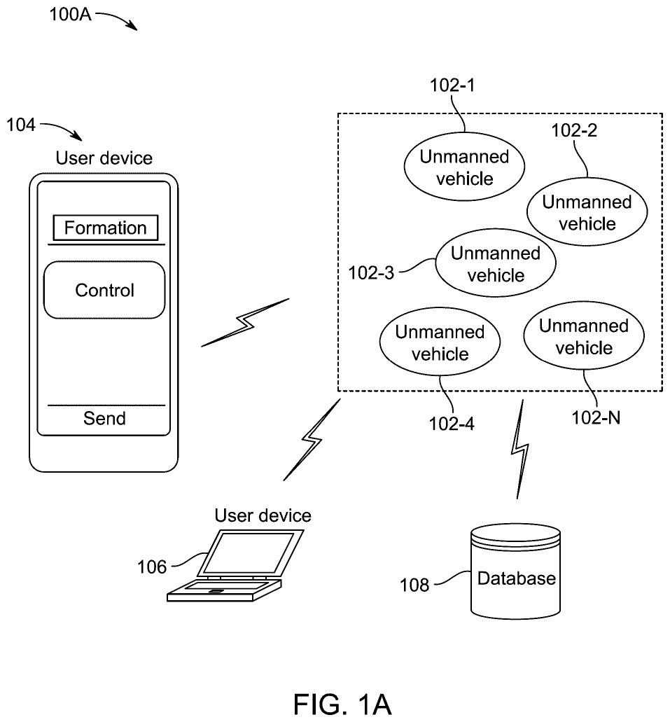

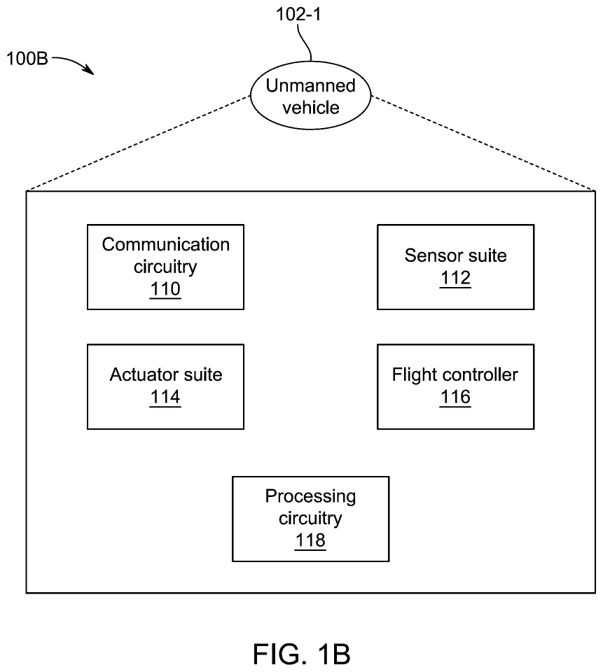

FIG. 1A illustrates a system 100A for controlling a trajectory of coordinated time-varying maneuvers of a geometric formation of unmanned vehicles. The system 100A includes multiple unmanned vehicles 102, depicted as unmanned vehicle 102-1, unmanned vehicle 102-2, unmanned vehicle 102-3, unmanned vehicle 102-4, and unmanned vehicle 102-N, representing the multiple unmanned vehicles, which operate in a leader-follower configuration. Each of the unmanned vehicles 102 is configured with communication circuitry to communicate among the multiple unmanned vehicles 102, wherein a subset of the unmanned vehicles are designated as leader vehicles, while the remaining unmanned vehicles are follower vehicles.

Unmanned vehicles, including unmanned aerial vehicles (UAVs), drones, or autonomous vehicles, are robotic systems that operate without human intervention. These vehicles can perform a wide range of tasks, from surveillance and reconnaissance to package delivery and agricultural monitoring. In the present system, the unmanned vehicles 102 are designed to operate in a coordinated geometric formation, which may involve a variety of maneuvers such as translation, rotation, scaling, and complex trajectory following. Each unmanned vehicle 102 can be equipped with multiple rotors, such as top-mounted rotors for aerial vehicles to move the unmanned aerial vehicle forward, backward, left, and right by adjusting speed of each rotor. The top-mounted rotors are driven by the actuator suite, or other propulsion systems depending on the type of vehicle and application. Examples include quadcopters, fixed-wing UAVs, or ground-based autonomous rovers.

The communication circuitry in each unmanned vehicle 102 is configured for maintaining coordinated movement. Communication circuitry refers to the hardware and software components that facilitate data exchange between vehicles, ensuring all vehicles are aware of each other's positions, speed, and trajectory plans. This data exchange is essential for leader-follower coordination, where leader vehicles define the trajectory, and follower vehicles maintain their relative positions. Different types of communication can be implemented, including wireless communication protocols such as Wi-Fi, Zigbee, LoRa, and 5G cellular networks. For example, Wi-Fi may be employed for short-range, high-speed communication, whereas LoRa may be used for long-range communication with lower data rates in environments with limited infrastructure.

The user devices 104 and 106, depicted in FIG. 1A as a smartphone and a laptop respectively, are used by operators to remotely control and manage the geometric formation of the unmanned vehicles 102. These user devices are equipped with software interfaces that allow operators to adjust flight parameters, initiate trajectory changes, and monitor the overall status of the formation. For instance, user device 104 may be used to provide real-time instructions for changing the formation shape during an operation, while user device 106 can be used to monitor system status, view sensor data, and upload mission plans. Examples of user devices may also include tablets, desktop computers, specialized remote controllers, and wearable devices such as smartwatches or augmented reality (AR) headsets, depending on the operational requirements. The user devices are also capable of communicating with the unmanned vehicles via wireless communication channels to send commands or receive status updates.

The system 100A also includes a database 108, which is responsible for storing flight-related data, including mission parameters, sensor data, actuator performance metrics, and historical flight records. This data can be used for post-flight analysis, performance optimization, and improving the resilience of the system against faults or cyber-attacks. For example, data stored in database 108 may be used to analyze the effects of actuator faults on vehicle stability or to assess the effectiveness of deception attack countermeasures. The database 108 can be implemented using various types of storage, including cloud-based storage solutions, local servers, or distributed storage systems. Different types of memory that can be utilized for storing the data include non-volatile memory such as solid-state drives (SSD), hard disk drives (HDD), flash memory, and magnetic tape storage, as well as volatile memory like random access memory (RAM) for temporary data processing.

Each unmanned vehicle 102 is equipped with an actuator suite and a sensor suite. The actuator suite is used to maintain and adjust the direction and orientation of the respective unmanned vehicle. For aerial vehicles, this may involve adjusting the speed of rotors to change altitude or direction, while for ground vehicles, it could involve controlling wheel motors or steering mechanisms. The sensor suite includes various sensors such as gyroscopes, accelerometers, and magnetometers, which provide real-time feedback on the vehicle's position, orientation, and movement. This sensor data is critical for maintaining stability and ensuring that each vehicle accurately follows the intended trajectory, particularly during complex maneuvers or when subjected to external disturbances.

The system 100A further employs processing circuitry configured for controlling the leader-follower maneuvering of the geometric formation of the plurality of unmanned vehicles 102. In a preferred embodiment, processing circuitry integrates a reinforcement learning neural network, comprising an identifier radial basis function neural network, an actor radial basis function neural network, and a critic radial basis function neural network. The identifier neural network estimates the nonlinear movement dynamics of the unmanned vehicles, while the actor neural network adjusts the direction and orientation of the vehicles based on these estimates. The critic neural network evaluates the performance of the adjustments using feedback from the sensor suite, which may include corrupted signals due to deception attacks. I should be understood, that the reinforcement learning framework can be configured using other types of neural networks or machine learning algorithms, in part depending on limitations of the hardware implementation. In some embodiments, reinforcement learning can be performed using an optimization control function.

The leader-follower coordination ensures that the unmanned vehicles 102 maintain a cohesive formation during maneuvers, even in the presence of faults or attacks. The processing circuitry's use of reinforcement learning allows the system to dynamically adapt to changing environmental conditions or unforeseen disturbances, such as actuator faults or sensor deception attacks, thereby maintaining the stability of the formation. For example, if a deception attack alters the sensor feedback for one of the follower vehicles, the critic neural network can identify inconsistencies in the sensor data, allowing the processing circuitry to adjust the control signals to maintain proper formation.

The communication between unmanned vehicles 102, user devices 104 and 106, and database 108, along with the actuator and sensor suites, provides a comprehensive control system for coordinated time-varying maneuvers of unmanned vehicles. The system 100A, through its combination of leader-follower maneuvering, communication circuitry, reinforcement learning, and adaptive processing, ensures effective control of the geometric formation of unmanned vehicles in dynamic environments.

FIG. 1B illustrates an unmanned vehicle system 100B. The system is configured to control the trajectory of coordinated time-varying maneuvers of a geometric formation of unmanned vehicles. A geometric formation refers to the specific spatial arrangement or configuration that a group of objects, in this context unmanned vehicles, maintain relative to each other while moving. In a geometric formation, the vehicles (e.g., UAVs) are organized to form predetermined shapes, such as a line, triangle, square, or more complex arrangements. The vehicles coordinate their movements to maintain this specific formation while navigating, which can help in tasks like area coverage, surveillance, and efficient navigation through obstacles. The formation is typically managed by leader-follower dynamics, where leader vehicles set the trajectory, and follower vehicles adjust their positions to maintain the intended configuration. This type of formation allows for coordinated, precise, and adaptable group behavior in complex environments.

The system 100B includes multiple unmanned vehicles 102. For purposes of this disclosure, the unmanned vehicles are unmanned aerial vehicles (UAV) that do not carry persons. As noted above, the unmanned vehicles can also include vehicles that travel under water or in outer space. Each of the unmanned vehicles is configured with a communication circuitry 110, a sensor suite 112, an actuator suite 114, a flight controller 116, and a processing circuitry 118. The communication circuitry 110 is configured to facilitate communication between each unmanned vehicle in the system. The communication circuitry 110 is essential for the leader-follower configuration, where leader vehicles coordinate the movements of follower vehicles to maintain the geometric formation and achieve target positions along the desired trajectory. Communication between the unmanned vehicles 102 enables the unmanned vehicles 102 to adjust their positions in real-time based on flight control signals and maintain formation cohesion. The communication circuitry 110 may use wireless communication protocols such as Wi-Fi for short-range, high-speed communication, or LoRa for long-range communication in low-data-rate environments. The ability of the communication circuitry 110 to switch between different protocols based on environmental conditions ensures uninterrupted communication even in challenging terrains or when infrastructure is limited. For example, in an urban environment, Wi-Fi might be used to enable high-speed data exchange, whereas in rural or remote areas, LoRa can provide long-range connectivity with lower power consumption. Other communication technologies that may be used include Zigbee for mesh networking or 5G/6G cellular networks for high bandwidth and low latency.

The sensor suite 112 is integrated into the unmanned vehicle 102-1 and is configured for stabilizing and navigating the unmanned vehicle 102. The sensor suite 112 includes one or more sensors, such as gyroscopes, accelerometers, and magnetometers that gather real-time data about the vehicle's orientation, speed, and position. Gyroscopes provide data on rotational movements, accelerometers measure linear acceleration, and magnetometers help determine the direction relative to Earth's magnetic field. This sensor data is utilized for maintaining stable flight, particularly in environments where the vehicle may be subjected to actuator faults or deception attacks on the sensor inputs. Additionally, the sensor suite 112 may include obstacle detection sensors, such as LiDAR or ultrasonic sensors, to detect and avoid obstacles in the flight path, enhancing the safety and reliability of the formation. For example, a LiDAR sensor can create a 3D map of the surrounding environment to help the vehicle navigate complex terrains, while ultrasonic sensors can detect obstacles at short ranges, making them suitable for low-speed maneuvers or landing operations. Visual sensors, such as cameras, can also be part of the sensor suite, providing image data that can be used for visual navigation, obstacle avoidance, or target recognition.

The actuator suite 114 in the unmanned vehicle 102-1 is configured to maintain and adjust direction and orientation of a respective unmanned vehicle 102. The actuator suite 114 adjusts the movement mechanisms of the vehicle, such as its rotors or movable fins, to execute the maneuvers for maintaining formation and trajectory. For aerial vehicles, the actuator suite 114 may include multiple top-mounted rotors, which can adjust the vehicle's altitude and direction by varying the rotor speeds. For example, if the unmanned vehicle 102 is a quadcopter, the actuator suite controls each of the four rotors independently to achieve the desired maneuver. In another example, a fixed-wing UAV may have an actuator suite 114 that includes movable control surfaces such as ailerons, rudders, and elevators to control the roll, yaw, and pitch of the vehicle. The actuator suite 114 works in conjunction with the flight controller 116 to ensure the unmanned vehicle 102 performs as expected, even when actuator faults occur, such as a rotor failure or reduced thrust due to mechanical issues. In the case of ground vehicles, the actuator suite 114 may include motors for wheel control and steering mechanisms to navigate across different terrains.

The flight controller 116 is configured for sending control signals to the actuator suite 114 and receiving feedback signals from the sensor suite 112. By configuring the flight controller 116, the unmanned vehicle 102 maintains stable maneuvering under challenging conditions, such as when the sensor suite 112 is subjected to deception attacks, or when the actuator suite 114 experiences malfunctions. The flight controller 116 processes real-time data from both the sensor suite 112 and the actuator suite 114 to generate appropriate control signals that ensure stable flight. For instance, if the sensor suite 112 detects a sudden deviation from the intended trajectory, the flight controller 116 immediately adjusts the actuator suite 114 to compensate for the deviation and bring the vehicle back on course. This closed-loop control mechanism is crucial for maintaining stability in dynamic and unpredictable environments. For example, if the vehicle encounters a sudden gust of wind that pushes it off course, the flight controller 116 adjusts the rotor speeds to counteract the disturbance and restore the intended trajectory. The flight controller 116 of each of the unmanned vehicles 102 executes program instructions to use sensor suite data to adjust the unmanned vehicle positioning and rotor speeds.

The processing circuitry 118 is configured for controlling the leader-follower maneuvering of the geometric formation. The processing circuitry 118 is configured to implement a reinforcement learning neural network that includes an identifier radial basis function neural network, an actor radial basis function neural network, and a critic radial basis function neural network. The identifier radial basis function neural network estimates nonlinear movements of the unmanned vehicle 102 by analyzing sensor data and predicting the vehicle's dynamic behavior. With such estimation, the processing circuitry 118 understands the current state of the vehicle and makes informed decisions regarding its movement. For example, the identifier neural network may predict the vehicle's response to a sudden change in wind speed, allowing the processing circuitry to pre-emptively adjust the control signals to maintain stability.

The actor radial basis function neural network adjusts the direction and orientation of the vehicle using the actuator suite 114, based on the estimated dynamics provided by the identifier radial basis function neural network. The actor radial basis function neural network determines the optimal control actions needed to maintain the desired trajectory and formation. For example, if the vehicle needs to change altitude to avoid an obstacle, the actor radial basis function neural network will compute the necessary rotor speed adjustments and send these commands to the actuator suite 114. In another instance, if the vehicle is part of a formation that needs to rotate to change its orientation, the actor radial basis function neural network calculates the adjustments required for each rotor or control surface to achieve the coordinated maneuver.

The critic radial basis function neural network assess the adjusted direction and orientation of each of the unmanned vehicles based on a feedback signal by the sensor suite 112. This feedback may include corrupted signals resulting from deception attacks, where adversaries inject false data to disrupt the vehicle's control system. The critic radial basis function neural network analyzes discrepancies between expected and actual sensor readings to determine if the vehicle is deviating from its intended path. If inconsistencies are detected, the critic radial basis function neural network prompts the processing circuitry to adjust the control strategy, ensuring the vehicle continues to perform as required despite interference or faults. For example, if the sensor data suggests that the vehicle is drifting off course due to a deception attack, the critic radial basis function neural network identifies the anomaly and instruct the processing circuitry to apply corrective measures, such as recalibrating the control inputs.

The reinforcement learning neural network integrated within the processing circuitry 118 allows the unmanned vehicle 102 to adapt its behavior dynamically in response to changing environmental conditions. Adaption includes learning a performance function that resets a preassigned convergence time whenever a target formation maneuver changes, thereby maintaining the transient states of each leader-follower tracking error within a predefined range. Such adaptability is particularly useful during complex maneuvers in a coordinated time-varying formation, such as changing the formation shape, direction, rotation, scaling, or translation, where the leader vehicles dictate the maneuver and the follower vehicles track their positions to achieve the target formation. For instance, if the leader vehicle initiates a scaling maneuver to expand the formation, the processing circuitry in each follower vehicle adjusts its movement to maintain the new distances between vehicles, ensuring the geometric formation is preserved.

The reinforcement learning neural network is also configured to learn a performance function through a performance-constrained backstepping control methodology. The reinforcement learning neural network initially generates an intermediate control input, which serves as a primary input for achieving stable control within the system in which backstepping control is applied.

In the backstepping control method, the system is based on the stability provided by the intermediate control input to systematically stabilize each outer control input progressively. Specifically, the reinforcement learning neural network assesses the stability requirements of the intermediate control, By following this structured stabilization process, the system progressively aligns each outer control input to achieve overall system stability and enhanced performance across the control layers.

In addition to the onboard components, the system 100B may further comprise a ground-based controller configured with the processing circuitry 118 for centralized control of the leader-follower maneuvering. The ground-based controller can be used to set mission objectives, define trajectories, and provide real-time monitoring of the unmanned vehicles 102. Communication between the ground-based controller and the unmanned vehicles 102 may be implemented using wireless communication protocols, ensuring that mission-critical data is exchanged reliably. For example, the ground-based controller may be a laptop equipped with specialized software that allows the operator to input mission parameters, view real-time telemetry data, and make adjustments to the flight plan as needed. In scenarios where multiple unmanned vehicles 102 are deployed, the ground-based controller can also serve as a coordination hub, ensuring that all vehicles operate in sync to achieve the mission goals.

The unmanned vehicle 102 is also capable of storing flight-related data, such as sensor readings, actuator performance, and mission parameters, in onboard memory. This memory may include both volatile memory, such as RAM, for temporary data processing, and non-volatile memory, such as flash storage or SSDs, for long-term data retention. This stored data can be used for post-mission analysis, system diagnostics, and improving future mission performance through machine learning techniques. For example, after a mission, the data stored in non-volatile memory can be analyzed to identify patterns in actuator performance, which can then be used to optimize future control strategies. Additionally, flight data can be uploaded to a central database for further analysis, enabling the development of predictive maintenance schedules to reduce the likelihood of actuator or sensor failures during missions.

With integration of communication circuitry 110, sensor suite 112, actuator suite 114, flight controller 116, and processing circuitry 118, the unmanned vehicle 102 operates autonomously and maintains the intended formation, even under challenging conditions such as actuator faults, sensor deception attacks, or environmental disturbances. The use of reinforcement learning and adaptive control strategies further enhances the resilience and reliability of the unmanned vehicle system 100B, making it suitable for a wide range of applications, including surveillance, reconnaissance, and cooperative missions in dynamic environments. For example, in a surveillance mission, the unmanned vehicle can autonomously navigate through an urban area, avoiding obstacles and maintaining formation with other vehicles, while continuously transmitting live video feed to the ground-based controller for real-time monitoring.

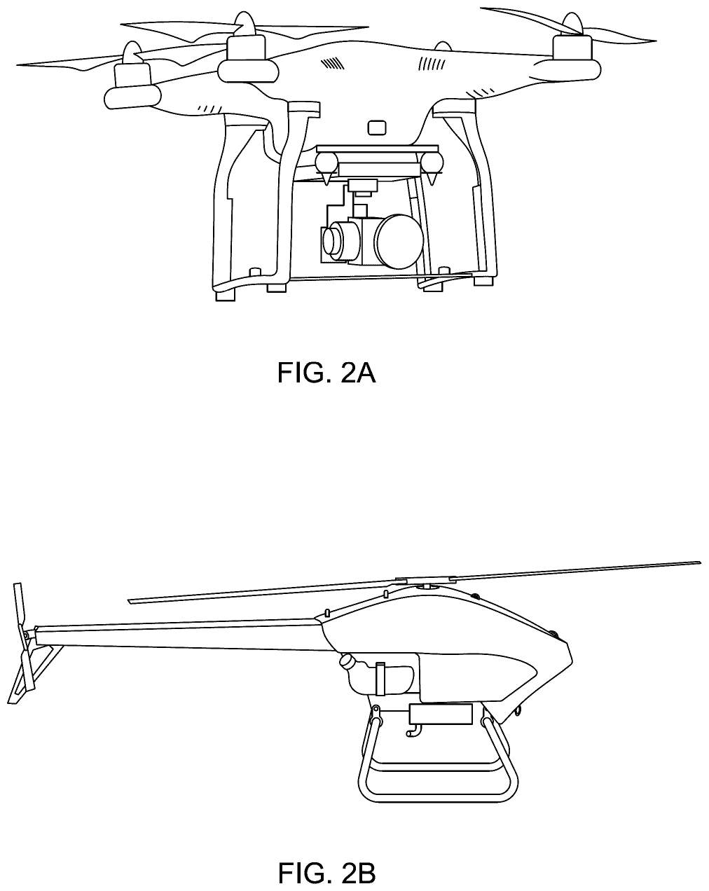

FIG. 2A depicts a quad-rotor UAV, illustrating a configuration used for executing coordinated maneuvers in a geometric formation. The UAV includes a main body that houses the primary electronics, sensors, and cameras. The UAV in FIG. 2A features a plurality of top-mounted rotors, which are part of the actuator suite. These rotors generate lift and thrust, allowing the UAV to maintain altitude, change direction, and stabilize during flight.

Each rotor is attached to a motor that forms part of the actuator suite. When actuated, the motors spin the rotors, producing thrust that enables the UAV to execute precise maneuvers and maintain stability. The motors are controlled via an electronic speed controller (ESC), which regulates the power delivered to each motor, ensuring smooth operation and consistent performance during flight. The rotors are essential for stabilizing the UAV in various flight conditions, including sudden shifts in wind or other environmental factors.

The UAV depicted in FIG. 2A operates within a system where it may function as either a leader vehicle or a follower vehicle, depending on its role in the formation. Communication circuitry within the UAV facilitates communication with other UAVs in the formation, exchanging flight control signals to maintain the designated trajectory. The UAV's sensor suite provides real-time feedback on its position, orientation, and environmental conditions, enabling effective navigation.

Additionally, the UAV is equipped with a camera module that captures high-resolution visual data used for navigation, obstacle detection, or mission-specific tasks, such as surveillance or terrain mapping. The captured video or image data can be transmitted in real-time to a ground control station or user device for further analysis and control. This camera is integral for autonomous operations in complex environments, enabling the UAV to detect obstacles, adjust its flight path, and execute mission tasks without manual intervention.

FIG. 2B illustrates a single rotor unmanned aerial vehicle, depicting a single-rotor UAV with multiple movable fins. The single rotor provides the necessary thrust to lift the UAV off the ground, while the movable fins are driven by the actuator suite that controls the UAV's direction and orientation during flight. With such configuration, the UAV to operate efficiently in different flight modes, whether hovering or moving along a designated flight path.

In this configuration, the sensor suite within the UAV, including devices such as gyroscopes, accelerometers, and magnetometers, continuously monitors the UAV's orientation, altitude, and motion. This sensor data is used to adjust the rotor speed and fin positions, ensuring stable flight and precise maneuvering, even in the presence of actuator faults or external disturbances.

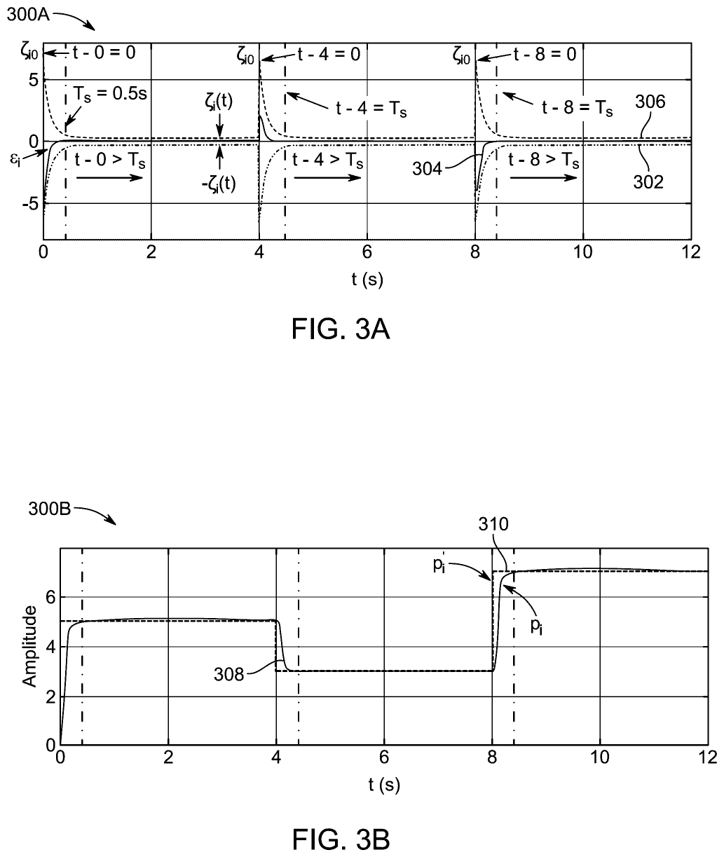

FIG. 3A represents the behavior of the tracking error εⁱ over time when a sudden change in the target trajectory pᵢ′ occurs at t=4 seconds and t=8 seconds.

The curve 302 represents the initial transient behavior of the tracking error εᵢ at t=0t=0t=0. Initially, the error εᵢ is at ζᵢ(0)-ζᵢ0=6. As time progresses, the error decays and converges to the steady-state value ζᵢₛ=0.3 at t=Tₛ=0.5 seconds. The black curve shows the system's ability to stabilize the error within the specified settling time, demonstrating the initial performance of the proposed function in regulating the transient state.

The curve 304 shows the system's performance when a sudden decrease in the target trajectory occurs at t=4 seconds. At this point, the finite-time performance function resets the transient state to ζᵢ(0)=ζᵢ0 and begins to decay toward the steady-state value ζᵢₛ. The red curve demonstrates the decay of the transient state after the reset, with the system settling within Ts=0.5 seconds. This behavior shows the ability of the proposed function to confine the new transient state within a predefined range and ensure convergence within the prescribed finite time.

The curve 306 illustrates the system's behavior when another sudden change in the target trajectory occurs at t=8 seconds. Once again, the performance function resets the transient state to ζᵢ(0)=ζⁱ0, and the error decays over time. Then the system settles at the steady-state value ζᵢₛ=0.3 within Tₛ=0.5 seconds after the transient state begins. This resetting behavior is analysed for ensuring that the system can handle multiple transient states in quick succession while maintaining accuracy and stability.

FIG. 3B represents the state trajectory pi tracking the target trajectory pᵢ′ as it undergoes sudden changes in amplitude at t=4 seconds and t=8 seconds. The behavior of the trajectory is represented by two curves, curve 308 and curve 310.

The curve 308 represents the state trajectory pᵢ as it tracks the target trajectory pᵢ′ when there is a sudden change in amplitude at t=4 seconds. At this point, the system resets the transient state, and the proposed finite-time performance function ensures that the trajectory pᵢ converges to the new steady-state value within the predefined settling time Tₛ=0.5 seconds. The curve shows how the system reacts to the first change in the target trajectory and how the performance function handles this transition effectively.

The curve 310 illustrates the state trajectory pi when the target trajectory pi′ undergoes another sudden change at t=8 seconds. The performance function resets the transient state at this point, and the trajectory converges to the new steady-state within the finite time Tₛ=0.5 seconds.

In the embodiment described with respect to FIG. 1A to 1C, graph theory is applied for modeling the communication and coordination among multiple agents in a multi-agent system (MAS) in two-dimensional space. The graph theory provides the mathematical foundation for defining and achieving the desired leader-follower formation topology and ensuring that agents can track their target positions while remaining coordinated in the presence of disturbances, faults, or changes in formation configuration. An undirected graph [symbol] =(ν, ε) is utilized to illustrate the communication among agents, which comprises a set of nodes ν={v₁, . . . , v_{N}} and a set of edges ε⊆ν×ν. The set of neighbors of an i^{th} agent is indicated by [symbol] ={j∈ν: (i, j)∈ε}. For an MAS of N agents in two-dimensional space whose positions are represented by pᵢ∈ [symbol] , i=1, 2, . . . , N, the formation of the agents is denoted by ( [symbol] , p) with

$$p = {[ \begin{matrix}{p}_{1}^{T} & {p}_{2}^{T} & … & {p}_{N}^{T}\end{matrix} ]}^{T} ∈ {ℝ}^{2 N}$$

being the configuration of the formation.

Define ( [symbol] , q) as the nominal formation of the agents, where

$$q = [ \begin{matrix}{q}_{1}^{T} & {{q}_{2}^{T} … {q}_{N}^{T} ]}^{T}\end{matrix} = {[ \begin{matrix}{q}_{l}^{T} & {q}_{f}^{T}\end{matrix} ]}^{T} ∈ {ℝ}^{2 N}$$

is the constant nominal configuration that the agents desired to form. The target configuration of the agents p′∈ [symbol] with various maneuvers is defined by:

$${p}^{′} ( t ) = [ {I}_{N} ⊗ A ( t ) ] q + {1}_{N} ⊗ b ( t ) \qquad ( 1 )$$

where A(t)∈ [symbol] realizes the time-varying scaling and rotation maneuvers of the whole formation while b(t)∈ [symbol] realizes the translation maneuver of the whole formation with respect to the nominal configuration q. Then, the target position

$${p}_{i}^{′} ∈ {ℝ}^{2}$$

of each agent from (1) is thus:

$${p}_{i}^{′} ( t ) = A ( t ) {q}_{i} + b ( t ) \qquad ( 2 )$$

To realize the affine transformation of the formation ( [symbol] , p), a stress ωᵢⱼ=ωⱼᵢ∈ [symbol] is assigned to the corresponding edge (i, j)∈ε. If the stresses applied to the configuration are balanced, then the following relation holds.

$${\sum }_{j ∈ {𝒩}_{i}} {ω}_{ij} ( {p}_{j} - {p}_{i} ) = 0 , i ∈ 𝒱 \qquad ( 3 )$$

Therefore, the stress is called equilibrium stress. The stress matrix is denoted by Ω∈ [symbol] and is defined as:

$${[ Ω ]}_{ij} = \{ \begin{matrix}0 , & i \neq j , ( i , j ) ∉ ε \\ - {ω}_{ij} , & i \neq j , ( i , j ) ∈ ε \\ {\sum }_{k ∈ {𝒩}_{i}} {ω}_{ik} , & i = j\end{matrix} .$$

The configuration of the agents can be divided into leaders and followers as:

$$p = {[ \begin{matrix}{p}_{l}^{T} & {p}_{f}^{T}\end{matrix} ]}^{T} \qquad ( 4 )$$

where

$${p}_{l} = {[ {p}_{1}^{T} {p}_{2}^{T} … {p}_{{N}_{l}}^{T} ]}^{T}$$

is the group of leaders and

$${p}_{f} = {[ {p}_{{N}_{l} + 1}^{T} {p}_{{N}_{l} + 2}^{T} … {p}_{{N}_{l} + {N}_{f}}^{T} ]}^{T}$$

is the group of followers, Nₗ and N_{f}=N−Nₗ are the numbers of leaders and followers, respectively.

The stress matrix Ω can be partitioned according to the followers and leaders groups as:

$$\overline{Ω} = Ω ⊗ {I}_{2} = [ \begin{matrix}{Ω}_{ll} & {Ω}_{lf} \\ {Ω}_{fl} & {Ω}_{ff}\end{matrix} ] ⊗ {I}_{2} = [ \begin{matrix}{\overline{Ω}}_{ll} & {\overline{Ω}}_{lf} \\ {\overline{Ω}}_{fl} & {\overline{Ω}}_{ff}\end{matrix} ] . \qquad ( 5 )$$

where Ωᵤ∈ [symbol] , Ω_{ff}∈ [symbol] and Ω_{fl}∈ [symbol] .

Definition 1: The nominal formation ( [symbol] , q) with q affinely span [symbol] is said to be localizable if the target position of the followers

$${p}_{f}^{′}$$

can be uniquely obtained from pₗ as follows:

$${p}_{f}^{′} = - ( {Ω}_{ff}^{- 1} {Ω}_{fl} ⊗ {I}_{d} ) {p}_{l} . \qquad ( 6 )$$

For Definition 1 to be valid, the nominal formation ( [symbol] , q) is set such that its stress matrix is positive semi-definite, and satisfies rank(Ω)=N−d−1 and Ω_{ff} is positive definite, with d=2 being the dimension of the agents in the Euclidean space.

In a first assumption,

$${p}^{′} = {[ \begin{matrix}{p}_{f}^{′ T} & {p}_{l}^{′ T}\end{matrix} ]}^{T}$$

is the vector of the target formation maneuvers of the agents, with

$${p}_{l}^{′} = {[ {p}_{1}^{′ T} {p}_{2}^{′ T} … {p}_{{N}_{l}}^{′ T} ]}^{T} and {p}_{f}^{′} = {[ {p}_{{N}_{l} + 1}^{′ T} {p}_{{N}_{l} + 2}^{′ T} … {p}_{{N}_{l} + {N}_{f}}^{′ T} ]}^{T} .$$

In this disclosure, it can be assumed that the leaders have obtained the desired formation maneuvers i.e.

$${p}_{l} = {p}_{l}^{′} and {u}_{l} = {u}_{l}^{′} .$$

Therefore, the control design for the leaders will be ignored. The control aim is now to realize

$${p}_{f} \to {p}_{f}^{′}$$

as t→Tₛ, with Tₛ is being a finite-time settling time.

The leader-follower MAS under consideration consists of Nₗ leaders and N_{f} followers. The leaders are governed by the following dynamic equations:

$$\{ \begin{matrix}{\dot{p}}_{i} = {v}_{i} \\ {\dot{v}}_{i} = {u}_{i} , i = 1 , 2 , … , {N}_{l}\end{matrix} \qquad ( 7 )$$

where pᵢ∈ [symbol] , vᵢ∈ [symbol] and uᵢ∈ [symbol] , i=1,2 . . . , Nₗ represent the positions, velocities, and control inputs of the leaders, respectively.

The followers are described by second-order nonlinear dynamic equations as follows:

$$\{ \begin{matrix}{\dot{p}}_{i} = {v}_{i} \\ {\dot{v}}_{i} = {g}_{i} ( {p}_{i} , {v}_{i} ) {\breve{u}}_{i} + {h}_{i} ( {p}_{i} , {v}_{i} ) + {ϑ}_{i} ( t ) \\ {\overline{p}}_{i} = {p}_{i} + {χ}_{i} ( t , {p}_{i} ) \\ {\overline{v}}_{i} = {v}_{i} + {χ}_{i} ( t , {v}_{i} ) , i = {N}_{l} + 1 , … , {N}_{l} + {N}_{f}\end{matrix} \qquad ( 8 )$$

where pᵢ∈ [symbol] and vᵢ∈ [symbol] represent the positions and velocities of the agents, respective, pᵢ∈ [symbol] and vᵢ∈ [symbol] are the positions and velocities of the agents under deception attacks, χᵢ(t, pᵢ) and χᵢ(t, vᵢ) are state-dependent deception attacks satisfying χᵢ(t, pᵢ)=wₚ_{ᵢ}pᵢ and χᵢ(t, vᵢ)=wᵥ_{ᵢ}vᵢ, with wₚ_{ᵢ} and wᵥ_{ᵢ} are time-varying and unknown, uᵢ∈ [symbol] , ŭᵢ∈ [symbol] represent the faulty actuator, hᵢ(pᵢ, vᵢ)∈ [symbol] is an unknown continuous nonlinear function, gᵢ∈ [symbol] ^{×2} is a diagonal matrix of unknown input gains, ϑᵢ(t)∈ [symbol] are the external disturbances.

In second assumption, the deception attack coefficients are Λₚ_{ᵢ}=(1+wₚ_{ᵢ}) and Λᵥ_{ᵢ}=(1+wᵥ_{ᵢ}), 1+wₚ_{ᵢ}≠0 and 1+wᵥ_{ᵢ}≠0 throughout the duration of the attack. The second assumption means that the system will remain controllable during the attack.

Let Λₚ_{ᵢ}=(1+wₚ_{ᵢ}) and Λᵥ_{ᵢ}=(1+wₚ_{ᵢ}). Then,

$$\{ \begin{matrix}{\overline{p}}_{i} = {Λ}_{{p}_{i}} {p}_{i} \\ {\overline{v}}_{i} = {Λ}_{{v}_{i}} {v}_{i}\end{matrix} , i = {N}_{l} + 1 , … , {N}_{l} + {N}_{f} \qquad ( 9 )$$

The model of the actuator fault ŭᵢ is described as:

$${\breve{u}}_{i} = {m}_{i} {u}_{i} + {δ}_{i} \qquad ( 10 )$$

where uᵢ∈ [symbol] is the control signal of each agent, and δᵢ=[δᵢ₁, δᵢ₂]^{T}∈ [symbol] is the vector of bias fault, mᵢ=diag{mᵢ₁, mᵢ₂}∈ [symbol] is a diagonal matrix of control effectiveness factors, and 0<mᵢ₁, mᵢ₂≤1.

Considering (9) and (10), (8) can be expressed as follows:

$$\{ \begin{matrix}{\dot{\overline{p}}}_{i} = & {Λ}_{pi} {Λ}_{vi}^{- 1} {\overline{v}}_{i} + {\dot{Λ}}_{pi} {Λ}_{pi}^{- 1} {\overline{p}}_{i} \\ {\dot{\overline{v}}}_{i} = & {Λ}_{{v}_{i}} {h}_{i} + {Λ}_{{v}_{i}} {m}_{i} {g}_{i} {u}_{i} + {Λ}_{{v}_{i}} {g}_{i} {δ}_{i} + {Λ}_{{v}_{i}} {ϑ}_{i} ; + {\dot{Λ}}_{{v}_{i}} {Λ}_{{v}_{i}}^{- 1} {\overline{v}}_{i} , i = {N}_{l} + 1 , … , {N}_{l} + {N}_{f}\end{matrix} \qquad ( 11 )$$

Defining:

$${p}_{f} = {[ {\overline{p}}_{{N}_{l} + 1}^{T} {\overline{p}}_{{N}_{l} + 2}^{T} … {\overline{p}}_{{N}_{l} + {N}_{f}}^{T} ]}^{T}$$

$${v}_{f} = {[ {\overline{v}}_{{N}_{l} + 1}^{T} {\overline{v}}_{{N}_{l} + 2}^{T} … {\overline{v}}_{{N}_{l} + {N}_{f}}^{T} ]}^{T}$$

$$h = {[ {h}_{{N}_{l} + 1}^{T} {h}_{{N}_{l} + 2}^{T} … {h}_{{N}_{l} + {N}_{f}}^{T} ]}^{T}$$

$$ϑ = {[ {ϑ}_{{N}_{l} + 1}^{T} {ϑ}_{{N}_{l} + 2}^{T} … {ϑ}_{{N}_{l} + {N}_{f}}^{T} ]}^{T}$$

$$δ = {[ {δ}_{{N}_{l} + 1}^{T} {δ}_{{N}_{l} + 2}^{T} … {δ}_{{N}_{l} + {N}_{f}}^{T} ]}^{T}$$

$${Λ}_{p} = diag \{ {Λ}_{{p}_{{N}_{l} + 1}} {Λ}_{{p}_{{N}_{l} + 2}} … {Λ}_{{p}_{{N}_{l} + {N}_{f}}} \}$$

$${Λ}_{v} = diag \{ {Λ}_{{v}_{{N}_{l} + 1}} {Λ}_{{v}_{{N}_{l} + 2}} … {Λ}_{{v}_{{N}_{l} + {N}_{f}}} \}$$

$$m = diag \{ {m}_{{N}_{l} + 1} {m}_{{N}_{l} + 2} … {m}_{{N}_{l} + {N}_{f}} \}$$

$$g = diag \{ {g}_{{N}_{l} + 1} {g}_{{N}_{l} + 2} … {g}_{{N}_{l} + {N}_{f}} \}$$

The global form of (11) is thus:

$$\{ \begin{matrix}{\dot{p}}_{f} = {Λ}_{p} {Λ}_{v}^{- 1} {v}_{f} + {\dot{Λ}}_{p} {Λ}_{p}^{- 1} {p}_{f} \\ {\dot{v}}_{f} = {Λ}_{v} mgu + {Λ}_{v} δ + {Λ}_{v} h + {Λ}_{v} ϑ + {\dot{Λ}}_{v} {Λ}_{v}^{- 1} {v}_{f}\end{matrix} \qquad ( 12 )$$

Define the following error variables for the followers:

$${ε}_{i} = {E}_{j = 1}^{N} {ω}_{ij} ( {p}_{i} - {p}_{j} ) , i = {N}_{l} + 1 , … , {N}_{l} + {N}_{f} \qquad ( 13 )$$

and the compact form of (13) is given by:

$$\begin{matrix}{ε}_{f} = {\overline{Ω}}_{ff} {p}_{f} + {\overline{Ω}}_{fl} {P}_{l} = {\overline{Ω}}_{ff} [ {p}_{f} - ( - {Ω}_{ff}^{- 1} {Ω}_{fl} ⊗ {I}_{d} ) {P}_{l} ] \\ {\overline{Ω}}_{ff} [ {p}_{f} - {p}_{f}^{′} ]\end{matrix} \qquad ( 14 )$$

where

$${ε}_{f} = {[ {ε}_{I}^{T} {ε}_{2}^{T} … {ε}_{{N}_{f}}^{T} ]}^{T}$$

and

$${p}_{f}^{′} = ( - {Ω}_{ff}^{- 1} {Ω}_{fl} ⊗ {I}_{d} ) {p}_{l}$$

as in (6).

Neural network approximations, specifically Radial Basis Function Neural Networks (RBFNNs), are implemented to manage the nonlinear functions that emerge from the design of the disclosed control strategy. In real-world multi-agent systems, it is challenging to represent complex nonlinear dynamics in closed-form equations suitable for real-time computation. RBFNNs approximate these functions, enabling accurate and efficient control.

The smooth and continuous nonlinear functions derived from the design of the disclosed control strategy are approximated with radial basis function neural networks (RBFNNs) as follows:

$${Ξ}_{i} = {W}_{i}^{T} {Φ}_{i} ( {X}_{i} ) + {ϵ}_{i} ( {X}_{i} ) \qquad ( 15 )$$

where Wᵢ=[wᵢ₁ wᵢ₂ . . . wᵢₘ]^{T}∈ [symbol] is the weight vector, m is the number of nodes, ϵᵢ(Xᵢ) is the RBFNN reconstruction error, error satisfying ∥ϵᵢ(Xᵢ)∥≤ϵₗ, Φᵢ(Xᵢ)=[Φᵢ₁(Xᵢ)Φᵢ₂(Xᵢ) . . . Φᵢₘ(Xᵢ)]^{T} is the vector of basis function with:

$${Φ}_{ik} ( {X}_{i} ) = exp ( - \frac{{‖ {X}_{i} - {η}_{1 k} ‖}^{2}}{{η}_{2 k}^{2}} ) , k = 1 , 2 , … , m \qquad ( 16 )$$

where η₁ₖ is the receptive center of the Gaussian function, η₂ₖ is the Gaussian function width.

The specified performance is attained by confining each leader-follower tracking error εᵢ, i=Nₗ+1, . . . , Nₗ+N_{f} within the following preassigned boundary.

$$- \underline{{δ}_{i}} {ζ}_{i} ( t ) < {ε}_{i} < {\overline{δ}}_{i} {ζ}_{i} ( t ) \qquad ( 17 )$$

where δᵢ>0 and δ̅ᵢ are design constants, ζᵢ(t): [symbol] → [symbol] is the prescribed performance function characterized as a positive, smooth, and decreasing function.

In second definition, a smooth function ζᵢ(t): [symbol] → [symbol] is said to be a finite time prescribed performance function if it is characterized by a) ζᵢ(t)>0; b) \dot{ζ}ᵢ(t)<0; c) lim_{t→t}_{ₛ}ζᵢ(t)=ζᵢₛ>0; and d) For any t≥tₛ, ζᵢ(t)=ζᵢₛ.

The finite time prescribed performance function proposed in this study is defined by:

$${ζ}_{i} ( t ) = \{ \begin{matrix}{ζ}_{i 0 ,} & t = {t}_{n} \\ & ( {ζ}_{i 0} - {ζ}_{is} ) exp ( \frac{- {K}_{i} ( t - {t}_{n} )}{{T}_{s}} ) + {ζ}_{is} , 0 < t - {t}_{n} < {T}_{s} \\ {ζ}_{i s ,} & t - {t}_{n} \geq {T}_{s} \\ & i = {N}_{l} + 1 , … , {N}_{l} + {N}_{f}\end{matrix} \qquad ( 18 )$$

where ζᵢ₀>0, ζᵢₛ>0, and κᵢ>0 are appropriately selected constants, Tₛ is the preassigned finite settling time, and tₙ is the time at which the agents undergo new transient states due to the change in target formation maneuver.

The inequality (17) can be transformed into an equality form using the following error transformation:

$${e}_{i} = Γ ( \frac{{ε}_{i}}{{ζ}_{i}} ) \qquad ( 19 )$$

where eᵢ is the transformed error, Γ(⋅) is a smooth function and Γ:(−δᵢ, δ̅ᵢ)→(−∞, ∞). The transformation function Γ(⋅)isexpressedas:

$$Γ ( \frac{{ε}_{i}}{{ζ}_{i}} ) = \frac{1}{2} ln ( \frac{\underline{{δ}_{i}} + \frac{{ε}_{i}}{{ζ}_{i}}}{{\overline{δ}}_{i} - \frac{{ε}_{i}}{{ζ}_{i}}} ) \qquad ( 20 )$$

The time derivative of the transformed error yields

$${\dot{e}}_{i} = {ℏ}_{i} ( {\dot{ε}}_{i} - \frac{{\dot{ζ}}_{i}}{{ζ}_{i}} {ε}_{i} ) i = {N}_{l} + 1 , … , {N}_{l} + {N}_{f} \qquad ( 21 )$$

where

$${ℏ}_{i} = \frac{1}{{ζ}_{i}} \frac{\partial {Γ}_{i}}{\partial ( {ε}_{i} / {ζ}_{i} )} .$$

To better demonstrate the important features of the performance function, a simple example is presented in FIG. 1. This figure shows a state trajectory pᵢ tracking a target trajectory [symbol] with sudden change in amplitudes at tₙ=4 s and tₙ=8 s. The trajectory pᵢ experienced new transient states at the time t=tₙ=4 s and t=tₙ=8 s. It is required that pᵢ settles at Tₛ seconds after every new transient state. The finite time performance function (18) can be reset and the new transient states of the tracking error E; can be constrained whenever the amplitude of the target trajectory changes.
Initially, t=tₙ=0 and ζᵢ(0)=ζᵢ₀=6. It is expected that as t grows, ζᵢ(t) converges to ζᵢₛ=0.3 at t=Tₛ=0.5s. Then, ζᵢ(t)=ζᵢₛ for t≥Tₛ.
When there is a sudden decrease in the target trajectory at t=tₙ=4 s, t−tₙ=0 and the finite time performance function is reset to ζᵢ(0)=ζᵢ₀ to confine the new transient state within the predefined range. As t grows (i.e t−4>0), the finite time performance function decays and settles at t−4=0.5s. For t−4≥0.5s, ζᵢ(t)=ζᵢₛ.
On the other hand, when the target trajectory suddenly increases at t=tₙ=8 s, t−tₙ=0. At this moment, the finite time performance function is reset such that ζᵢ(0)=ζᵢ₀ and begins decaying for t−8>0 until t−8=0.5s where it settles at ζᵢ(t)=ζᵢₛ. Subsequently, for t−8≥0.5s, ζᵢ(t)=ζᵢₛ.

$${ζ}_{i} ( t ) = ( {ζ}_{i 0} - {ζ}_{i ∞} ) {e}^{- {κ}_{i} t} + {ζ}_{i ∞} \qquad ( 22 )$$

$${ζ}_{i} ( t ) = {ζ}_{i 0} exp ( \frac{- t}{{κ}_{i}} ) + {ζ}_{i ∞} \qquad ( 23 )$$

$${ζ}_{i} ( t ) = coth ( {κ}_{1 i} t + {κ}_{i 2} ) - 1 + {ζ}_{i ∞} \qquad ( 24 )$$

$${ζ}_{i} ( t ) = \{ \begin{matrix}( {ζ}_{i 0} - {ζ}_{is} ) exp ( \frac{- {κ}_{i} {T}_{s} t}{t - {T}_{s}} ) + {ζ}_{is} , & t < {T}_{s} \\ {ζ}_{is} , & t \geq {T}_{s}\end{matrix} \qquad ( 25 )$$

$${ζ}_{i} ( t ) = \{ \begin{matrix}{ζ}_{i 0} exp ( {κ}_{i} ( 1 - \frac{{T}_{s}}{{T}_{s} - t} ) ) {ϖ}_{i} + {ζ}_{is} , & t < {T}_{s} \\ {ϖ}_{i} = \frac{1}{2} cos ( \frac{π t}{{T}_{s}} ) + \frac{1}{2} & \\ \\ {ζ}_{is} , & t \geq {T}_{s}\end{matrix} \qquad ( 26 )$$

$${ζ}_{i} ( t ) = \{ \begin{matrix}( 1 - \frac{t}{{T}_{s}} ) {exp}^{1 - exp ( \frac{{T}_{s}}{{T}_{s} - t} )} + {ζ}_{is} , & t < {T}_{s} \\ {ζ}_{is} , & t \geq {T}_{s}\end{matrix} \qquad ( 27 )$$

$${ζ}_{i} ( t ) = \{ \begin{matrix}( {ζ}_{i 0} - \frac{t}{{κ}_{i} {T}_{s}} ) & \\ \\ \times exp ( 1 - tan ( \frac{t}{{T}_{s} - t} ) ) + {ζ}_{is} , & t < {T}_{s} \\ {ζ}_{is} , & t \geq {T}_{s}\end{matrix} \qquad ( 28 )$$

$${ζ}_{i} ( t ) = \{ \begin{matrix}( {ζ}_{i 0} - {ζ}_{is} ) {( 1 - \frac{t}{{T}_{s}} )}^{{κ}_{i}} + {ζ}_{is} , & t < {T}_{s} \\ {ζ}_{is} , & t \geq {T}_{s}\end{matrix} \qquad ( 29 )$$

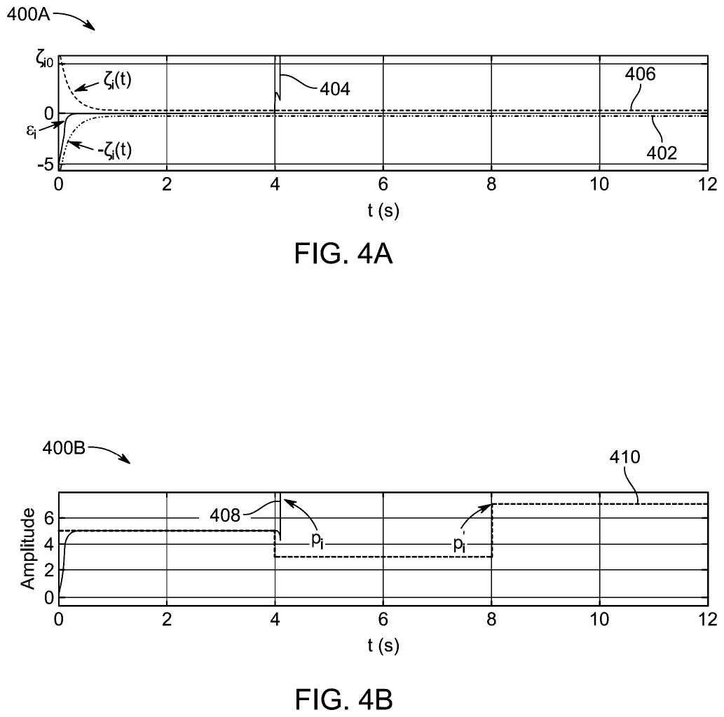

FIG. 4A depicts the behavior 400A of the tracking error εᵢ under a sudden change in the target trajectory at t=4 seconds. The behavior of the system is represented by curve 402, curve 404, and curve 406.

Curve 402 represents the initial behavior of the tracking error εᵢ when the performance function is unable to reset the transient state after a sudden change in the target trajectory. Initially, the tracking error εᵢ follows the predefined trajectory, but at t=4 seconds, the system becomes unstable due to the inability of the performance function to adjust to the new transient state. Curve 402 shows the system's failure to maintain stability when faced with sudden reference signal changes.

Curve 404 shows the tracking error εᵢ experiencing instability after the sudden change at t=4 seconds. The lack of a reset mechanism in the existing performance functions prevents the system from controlling the new transient state, resulting in an erratic response. Curve 404 shows that the tracking error fails to converge to the desired steady-state after the target trajectory shifts, reinforcing the need for a modified performance function that can reset and accommodate multiple transient states.

Curve 406 further demonstrates the inability of the system to handle the sudden change in the target trajectory. The error remains outside the desired range, and the system cannot stabilize the transient state, leading to prolonged instability. Curve 406 indicates the limitations of existing performance functions (22)-(29) in handling sudden shifts in the target trajectory and tracking errors over time.

FIG. 4B illustrates an observation 400B of the state trajectory pᵢ tracking the target trajectory pᵢ′ when sudden changes in amplitude occur at t=4 seconds. The performance of the state trajectory is depicted by curve 408 and curve 410.

Curve 408 shows the behavior of the state trajectory pi as it initially tracks the target trajectory pᵢ′ without issues. However, at t=4 seconds, the target trajectory pᵢ′ changes abruptly. Due to the limitations of performance functions (22)-(29), the system cannot reset the transient state of the tracking error, leading to instability in the state trajectory. The inability to reset and stabilize is clearly demonstrated in this curve, as the trajectory pi becomes erratic after the sudden change.

Curve 410 represents the expected trajectory of pᵢ had the system been able to properly handle the sudden change in the target trajectory at t=4 seconds. Curve 410 shows that the state trajectory would have stabilized if the performance function could reset to accommodate the new transient state. However, the existing performance functions fail to achieve this reset, resulting in divergence from the target trajectory. The divergence shows the core limitation of performance functions (22)-(29) in applications where mobile agents experience multiple transient states.

Optimal backstepping control laws are obtained from the approximate solution of the Hamilton-Jacobi-Bellman equation using reinforcement learning under the identifier-actor-critic neural networks. Subsequently, reinforcement learning-based optimized secure backstepping control can be realized for nonlinear leader-follower multi-agent systems with deception attacks and actuator faults to be resilient and realize various affine formation maneuvers. The objective of the controller is to ensure that the closed-loop system is bounded despite the actuator and the deceptive state signals injected by cyber-attackers.

### Defining:

$${e}_{f} = {[ {e}_{1}^{T} {e}_{2}^{T} … {e}_{{N}_{f}}^{T} ]}^{T}$$

$${ζ}_{f} = diag \{ {\dot{ζ}}_{1} / {ζ}_{1} {\dot{ζ}}_{2} / {ζ}_{2} … {\dot{ζ}}_{{N}_{f}} / {ζ}_{{N}_{f}} \}$$

$${ℏ}_{f} = \{ {ℏ}_{1} {ℏ}_{2} … {ℏ}_{{N}_{f}} \}$$

The global form of (21) is given by:

$$\begin{matrix}{\dot{e}}_{f} = {ℏ}_{f} ( {\dot{ε}}_{f} - {ζ}_{f} {ε}_{f} ) \\ = {ℏ}_{f} {\overline{Ω}}_{ff} ( {Λ}_{p} {Λ}_{v}^{- 1} {v}_{f} + {\dot{Λ}}_{p} {Λ}_{p}^{- 1} {p}_{f} - {\dot{p}}_{f}^{′} ) - {ζ}_{f} {ℏ}_{f} {ε}_{f}\end{matrix} \qquad ( 30 )$$

According to the backstepping approach, v_{f} will be treated as the intermediate control input. Let α_{f} be the virtual control. Then, define the error z_{f}=v_{f}−α_{f}, and its time-derivative is calculated as:

$$\begin{matrix}{\dot{z}}_{f} = {\dot{v}}_{f} - {\dot{α}}_{f} \\ = {Λ}_{v} mgu + {Λ}_{v} g δ + {Λ}_{v} h + {Λ}_{v} \partial + {\dot{Λ}}_{v} {Λ}_{v}^{- 1} {v}_{f} - {\dot{α}}_{f}\end{matrix} \qquad ( 31 )$$

For the purpose of a control scheme, the error dynamics (30) and (31) are transformed as follows:

$$\begin{matrix}{\dot{e}}_{f} = ϒ ( {p}_{f} , {v}_{f} , {Λ}_{p} , {Λ}_{v} ) + {v}_{f} \\ = ϒ ( {p}_{f} , {v}_{f} , {Λ}_{p} , {Λ}_{v} ) + {z}_{f} + {α}_{f}\end{matrix} \qquad ( 32 )$$

$${\dot{z}}_{f} = F ( {p}_{f} , {v}_{f} , {Λ}_{p} , {Λ}_{v} , u ) + u - {\dot{α}}_{f} \qquad ( 33 )$$

where

$$ϒ ( {p}_{f} , {v}_{f} , {Λ}_{p} , {Λ}_{v} ) = {ℏ}_{f} {\overline{Ω}}_{ff} ( {Λ}_{p} {Λ}_{v}^{- 1} {v}_{f} + {\dot{Λ}}_{p} {Λ}_{p}^{- 1} {p}_{f} - {\dot{p}}_{f}^{′} ) - {ζ}_{f} {ℏ}_{f} {ε}_{f} - {v}_{f}$$

$$and$$

$$F ( {p}_{f} , {v}_{f} , {Λ}_{p} , {Λ}_{v} , u ) = {Λ}_{v} mgu + {Λ}_{v} g δ + {Λ}_{v} h + {Λ}_{v} \partial + {\dot{Λ}}_{v} {Λ}_{v}^{- 1} {v}_{f} - u .$$

A performance index function associated with es and as is defined as follows:

$${I}_{p} ( {e}_{f} ) = {\int }_{t}^{∞} {r}_{f} ( {e}_{f} ( τ ) , {α}_{f} ( τ ) ) d τ \qquad ( 34 )$$

where

$${r}_{f} ( {e}_{f} , {α}_{f} ) = {e}_{f}^{T} {e}_{f} + {α}_{f}^{T} {α}_{f}$$

is the cost function. The optimal performance index I*(e_{f}) associated with the optimal virtual controller

$${α}_{f}^{*}$$

is given by:

$$\begin{matrix}{I}_{p}^{*} ( {e}_{f} ) = {min}_{{α}_{f} ∈ Π} ( {\int }_{t}^{∞} {r}_{f} ( {e}_{f} ( τ ) , {α}_{f} ( τ ) ) d τ ) \\ = {\int }_{t}^{∞} ( {e}_{f}^{T} {e}_{f} + {α}_{f}^{* T} {α}_{f}^{*} ) d τ\end{matrix} \qquad ( 35 )$$

where Π is the set of admissible control inputs. From (35), the following Hamilton-Jacobi-Bellman (HJB) equation can be derived:

$${H}_{p} ( {e}_{f} , {α}_{f}^{*} , \frac{\partial {I}_{p}^{*}}{\partial {e}_{f}} ) = {r}_{f} ( {e}_{f} , {α}_{f}^{*} ) + \frac{\partial {I}_{p}^{*}}{\partial {e}_{f}} {\dot{e}}_{f} = {e}_{f}^{T} {e}_{f} + {α}_{f}^{* T} {α}_{f}^{*} + \frac{\partial {I}_{p}^{*}}{\partial {e}_{f}} ( {z}_{f} + {α}_{f} + ϒ - {p}_{f}^{′} ) = 0 \qquad ( 36 )$$

where

$$\frac{\partial {I}_{p}^{*}}{\partial {e}_{f}}$$

is the gradient of

$${I}_{p}^{*}$$

along e_{f}. Suppose the solution of (36) exists and is unique, the optimal control policy

$${α}_{f}^{*}$$

can be achieved by computing

$$\partial {H}_{p} ( {e}_{f} , {α}_{f}^{*} , \frac{\partial {I}_{p}^{*}}{\partial {e}_{f}} ) / \partial {α}_{f}^{*} = 0$$

$${α}_{f}^{*} = - \frac{1}{2} \frac{\partial {I}_{p}^{*} ( {e}_{f} )}{\partial {e}_{f}} \qquad ( 37 )$$

Considering (36) and (37), it is clear that

$$\frac{\partial {I}_{p}^{*}}{\partial {e}_{f}}$$

is required to obtain the solution of (36). Nevertheless, due to the unknown deception attack signals and strong nonlinearities, it is impossible to solve (36). To achieve the control objective, RL actor-critic framework is employed to obtain the approximate solution online.
By using some mathematical manipulations,

$$\frac{\partial {I}_{p}^{*}}{\partial {e}_{f}}$$

can be expressed as follows:

$$\frac{\partial {I}_{p}^{*} ( {e}_{f} )}{\partial {e}_{f}} = 2 {K}_{1} {e}_{f} + 2 ϒ + {I}_{p}^{0} \qquad ( 38 )$$

where

$${I}_{p}^{0} = - 2 {K}_{1} {e}_{f} - 2 ϒ + \frac{\partial {I}_{p}^{*} ( {e}_{f} )}{\partial {e}_{f}} .$$

Inserting (38) into (37) gives:

$${α}_{f}^{*} = - {K}_{p} {e}_{f} - ϒ - \frac{1}{2} {I}_{p}^{0} \qquad ( 39 )$$

Since the continuous functions Y and

$${I}_{p}^{0}$$

are unknown, RBFNNs are employed to approximate them in the following form:

$$ϒ = {W}_{ϒ}^{* T} {Φ}_{ϒ} ( {X}_{ϒ} ) + {ϵ}_{ϒ} ( {X}_{ϒ} ) \qquad ( 40 )$$

$${I}_{p}^{0} = {W}_{{I}_{p}}^{* T} {Φ}_{{I}_{p}} ( {X}_{{I}_{p}} ) + {ϵ}_{{I}_{p}} ( {X}_{{I}_{p}} ) \qquad ( 41 )$$

where

$${W}_{ϒ}^{*} and {W}_{{I}_{p}}^{*}$$

are the ideal weights, Φ_{γ}(X_{γ}) and Φₗₚ(Xₗₚ) are the vectors basis functions, and ϵ_{γ}(X_{γ}) and ϵₗₚ(Xₗₚ) are the RBFNN approximation errors.
Substituting (40) and (41) into (38) and (39), respectively:

$$\frac{\partial {I}_{p}^{*} ( {e}_{f} )}{\partial {e}_{f}} = 2 {K}_{1} {e}_{f} + 2 {W}_{ϒ}^{* T} {Φ}_{ϒ} ( {X}_{ϒ} ) + {W}_{{I}_{p}}^{* T} {Φ}_{{I}_{p}} ( {X}_{{I}_{p}} ) + {ϵ}_{p} \qquad ( 42 )$$

$${α}_{f}^{*} = - {K}_{p} {e}_{f} - {W}_{ϒ}^{* T} {Φ}_{ϒ} ( {X}_{ϒ} ) - \frac{1}{2} {W}_{{I}_{p}}^{* T} {Φ}_{{I}_{p}} ( {X}_{{I}_{p}} ) + {ϵ}_{p} \qquad ( 43 )$$

where ϵₚ=ϵ_{γ}(X_{γ})+ϵₗₚ(Xₗₚ).
The optimal control input (43) cannot be used because of the unknown weights

$${W}_{ϒ}^{*} and {W}_{{I}_{p}}^{*} .$$

The identifier RBFNN is used to estimate the unknown deceptive signals as:

$$\hat{ϒ} = {\hat{W}}_{ϒ}^{T} {Φ}_{ϒ} ( {X}_{ϒ} ) \qquad ( 44 )$$

where Ŵ_{γ} is the weight of the identifier, and \hat{γ} is the output of the identifier. The RBFNN weight of the identifier

$${\hat{W}}_{ϒ}^{T}$$

is updated online by:

$${\dot{\hat{W}}}_{ϒ} = {Γ}_{p} ( {Φ}_{ϒ} ( {X}_{ϒ} ) {e}_{f} - {σ}_{p} {\hat{W}}_{ϒ} ) \qquad ( 45 )$$

where Γₚ is a positive-definite matrix and σₚ>0 is a small constant.
To obtain the optimized controller, the actor, critic, and identifier framework is developed:

$$\frac{\partial {\hat{I}}_{p} ( {e}_{f} )}{\partial {e}_{f}} = 2 {K}_{1} {e}_{f} + 2 {\hat{W}}_{ϒ}^{* T} {Φ}_{ϒ} ( {X}_{ϒ} ) + {\hat{W}}_{{c}_{p}}^{* T} {Φ}_{{I}_{p}} ( {X}_{{I}_{p}} ) \qquad ( 46 )$$

$${\hat{α}}_{f}^{*} = - {K}_{p} {e}_{f} - {\hat{W}}_{ϒ}^{* T} {Φ}_{ϒ} ( {X}_{ϒ} ) - \frac{1}{2} {\hat{W}}_{{a}_{p}}^{* T} {Φ}_{{I}_{p}} ( {X}_{{I}_{p}} ) \qquad ( 47 )$$

where

$$\frac{\partial {\hat{I}}_{p} ( {e}_{f} )}{\partial {e}_{f}}$$

is the estimate of

$$\frac{\partial {I}_{p} ( {e}_{f} )}{\partial {e}_{f}} , {\hat{W}}_{{c}_{p}}^{*} and {\hat{W}}_{{a}_{p}}^{*}$$

are the estimates of the critic and actor weights, respectively.
Adding (46) and (47) into (36), the approximated HJB equation is derived as:

$${H}_{p} ( {e}_{f} , {\hat{α}}_{f}^{*} , \frac{\partial {\hat{I}}_{p}}{\partial {e}_{f}} ) = \qquad ( 48 )$$

$${e}_{f}^{T} {e}_{f} + {( - {K}_{p} {e}_{f} - {\hat{W}}_{ϒ}^{* T} {Φ}_{ϒ} ( {X}_{ϒ} ) - \frac{1}{2} {\hat{W}}_{{a}_{p}}^{* T} {Φ}_{{I}_{p}} ( {X}_{{I}_{p}} ) )}^{T} \times ( - {K}_{p} {e}_{f} - {\hat{W}}_{ϒ}^{* T} {Φ}_{ϒ} ( {X}_{ϒ} ) - \frac{1}{2} {\hat{W}}_{{a}_{p}}^{* T} {Φ}_{{I}_{p}} ( {X}_{{I}_{p}} ) ) + ( 2 {K}_{1} {e}_{f} + 2 {\hat{W}}_{ϒ}^{* T} {Φ}_{ϒ} ( {X}_{ϒ} ) + {\hat{W}}_{{c}_{p}}^{* T} {Φ}_{{I}_{p}} ( {X}_{{I}_{p}} ) ) \times$$

$$( {z}_{f} + ϒ - {K}_{p} {e}_{f} - {\hat{W}}_{ϒ}^{* T} {Φ}_{ϒ} ( {X}_{ϒ} ) - \frac{1}{2} {\hat{W}}_{{a}_{p}}^{* T} {Φ}_{{I}_{p}} ( {X}_{{I}_{p}} ) )$$

The Bellman's residual error \tilde{H}ₚ is expressed as:

$${\tilde{H}}_{p} = {H}_{p} ( {e}_{f} , {\hat{α}}_{f}^{*} , \frac{\partial {\hat{I}}_{p}}{\partial {e}_{f}} ) - {H}_{p} ( {e}_{f} , {α}_{f}^{*} , \frac{\partial {I}_{p}^{*}}{\partial {e}_{f}} ) \qquad ( 49 )$$

Considering (36), (49) becomes:

$${\tilde{H}}_{p} = {H}_{p} ( {e}_{f} , {\hat{α}}_{f}^{*} , \frac{\partial {\hat{I}}_{p}}{\partial {e}_{f}} ) \qquad ( 50 )$$

With regards to (48), it is desired that

$${\hat{α}}_{f}^{*}$$

realizes.

$${\tilde{H}}_{p} = {H}_{p} ( {e}_{f} , {\hat{α}}_{f}^{*} , \frac{\partial {\hat{I}}_{p}}{\partial {e}_{f}} ) \to 0.$$

### If

$${H}_{p} ( {e}_{f} , {\hat{α}}_{f}^{*} , \frac{\partial {\hat{I}}_{p}}{\partial {e}_{f}} ) = 0$$

ensued, the following also hold:

$$\frac{{\partial }_{f} {H}_{p} ( {e}_{f} , {\hat{α}}_{f}^{*} , \frac{\partial {\hat{I}}_{p}}{\partial {e}_{f}} )}{\partial {\hat{W}}_{{a}_{p}}} = \frac{1}{2} {Φ}_{{I}_{p}}^{T} {Φ}_{{I}_{p}} ( {\hat{W}}_{{a}_{p}} - {\hat{W}}_{{c}_{p}} ) = 0 \qquad ( 51 )$$

To derive the weight updating laws for Ŵₐ_{ₚ} and Ŵ_{c}_{ₚ} to guarantee (51), a positive definite function Sₚ is defined as:

$${S}_{p} = {( {\hat{W}}_{{a}_{p}} - {\hat{W}}_{{c}_{p}} )}^{T} ( {\hat{W}}_{{a}_{p}} - {\hat{W}}_{{c}_{p}} ) \qquad ( 52 )$$

Clearly, Sₚ=0 is equivalent to (51). Noting that ∂Sₚ/∂Ŵₐ_{ₚ}=−∂Sₚ/∂Ŵ_{c}_{ₚ}=2 (Ŵₐ_{ₚ}−Ŵ_{c}_{ₚ}), the time derivative of Sₚ gives

$$\begin{matrix}\frac{d {S}_{p}}{dt} = \frac{\partial {S}_{p}}{\partial {\hat{W}}_{{c}_{p}}^{T}} {\dot{\hat{W}}}_{{c}_{p}} + \frac{\partial {S}_{p}}{\partial {\hat{W}}_{{a}_{p}}^{T}} {\dot{\hat{W}}}_{{a}_{p}} = - {k}_{c} \frac{\partial {S}_{p}}{\partial {\hat{W}}_{{c}_{p}}^{T}} {Φ}_{{I}_{p}}^{T} {Φ}_{{I}_{p}} {\hat{W}}_{{c}_{p}} - \\ \frac{\partial {S}_{p}}{\partial {\hat{W}}_{{a}_{p}}^{T}} {Φ}_{{I}_{p}}^{T} {Φ}_{{I}_{p}} ( {k}_{a} ( {\hat{W}}_{{a}_{p}} - {\hat{W}}_{{c}_{p}} ) + {k}_{c} {\hat{W}}_{{c}_{p}} ) \\ = - \frac{{k}_{a}}{2} \frac{\partial {S}_{p}}{\partial {\hat{W}}_{{a}_{p}}^{T}} {Φ}_{{I}_{p}}^{T} {Φ}_{{I}_{p}} \frac{\partial {S}_{p}}{\partial {\hat{W}}_{ai}} \leq 0\end{matrix} \qquad ( 53 )$$

The RBFNN weight of the critic is updated as follows:

$${\dot{\hat{W}}}_{{c}_{p}} = - {γ}_{{c}_{p}} {Φ}_{{I}_{p}}^{T} {Φ}_{{I}_{p}} {\hat{W}}_{{c}_{p}} \qquad ( 54 )$$

where γ_{c}_{ₚ}>0 is a constant.
The RBFNN weight of the actor is updated as follows:

$${\dot{\hat{W}}}_{{a}_{p}} = - {Φ}_{{I}_{p}}^{T} {Φ}_{{I}_{p}} ( {γ}_{{a}_{p}} ( {\hat{W}}_{{a}_{p}} - {\hat{W}}_{{c}_{p}} ) + {γ}_{{c}_{p}} {\hat{W}}_{{c}_{p}} ) \qquad ( 55 )$$

where γₐ_{ₚ}>0 is a constant.
Using the approximate optimal controller (47), the error dynamics (32) can be rewritten as:

$${\dot{e}}_{f} = {z}_{f} + {\hat{a}}_{f}^{*} + ϒ \qquad ( 56 )$$

A Lyapunov candidate function is selected for the er subsystem as:

$${L}_{1} = \frac{1}{2} {e}_{f}^{T} {e}_{f} + \frac{1}{2} {\tilde{W}}_{ϒ}^{T} {Γ}_{p}^{- 1} {\tilde{W}}_{ϒ} + \frac{1}{2} {\tilde{W}}_{{c}_{p}}^{T} {\tilde{W}}_{{c}_{p}} + \frac{1}{2} {\tilde{W}}_{{a}_{p}}^{T} {\tilde{W}}_{{a}_{p}} \qquad ( 57 )$$

where

$${\tilde{W}}_{Υ} = {\hat{W}}_{Υ} - {W}_{Υ}^{*} , {\tilde{W}}_{{a}_{p}} = {\hat{W}}_{{a}_{p}} - {W}_{{I}_{p}}^{*} , and {\tilde{W}}_{{c}_{p}} = {\hat{W}}_{{c}_{p}} - {W}_{{I}_{p}}^{*}$$

are the RBFNN weight errors for the identifier, actor, and critic networks, respectively.

Differentiating L₁ with respect to time and considering (45), (54), and (55), one gets:

$${\dot{L}}_{1} = {e}_{f} ( {z}_{f} + {\hat{α}}_{f}^{*} + ϒ ) + {\tilde{W}}_{ϒ}^{T} ( {Φ}_{ϒ}^{T} {e}_{f} - {σ}_{p} {\hat{W}}_{ϒ} ) - {γ}_{{c}_{p}} {\tilde{W}}_{{c}_{p}}^{T} {Φ}_{{I}_{p}}^{T} {Φ}_{{I}_{p}} {\hat{W}}_{{c}_{p}} - {\tilde{W}}_{{a}_{p}}^{T} {Φ}_{{I}_{p}}^{T} {Φ}_{{I}_{p}} ( {γ}_{{a}_{p}} ( {\hat{W}}_{{a}_{p}} - {\hat{W}}_{{c}_{p}} ) + {γ}_{{c}_{p}} {\hat{W}}_{{c}_{p}} ) \qquad ( 58 )$$

Inserting (40) and (47) into (58), one gets:

$${\dot{L}}_{1} = {e}_{f} ( - {K}_{p} {e}_{f} - \frac{1}{2} {\hat{W}}_{{a}_{p}}^{T} {Φ}_{{I}_{p}} ( {X}_{{I}_{p}} ) - {\tilde{W}}_{ϒ}^{T} {Φ}_{ϒ} ( {X}_{ϒ} ) + {ϵ}_{ϒ} + {z}_{f} ) + {\tilde{W}}_{ϒ}^{T} ( {Φ}_{ϒ}^{T} {e}_{f} - {σ}_{p} {\hat{W}}_{ϒ} ) - {γ}_{{c}_{p}} {\tilde{W}}_{{c}_{p}}^{T} {Φ}_{{I}_{p}}^{T} {Φ}_{{I}_{p}} {\hat{W}}_{{c}_{p}} - {\tilde{W}}_{{a}_{p}}^{T} {Φ}_{{I}_{p}}^{T} {Φ}_{{I}_{p}} ( {γ}_{{a}_{p}} ( {\hat{W}}_{{a}_{p}} - {\hat{W}}_{{c}_{p}} ) + {γ}_{{c}_{p}} {\hat{W}}_{{c}_{p}} ) \qquad ( 59 )$$

Equation (59) can be re-expressed as follows:

$${\dot{L}}_{1} = - {e}_{f} {K}_{p} {e}_{f} + {e}_{f} {ϵ}_{ϒ} + {e}_{f} {z}_{f} - \frac{1}{2} {e}_{f}^{T} {\hat{W}}_{{a}_{p}}^{T} {Φ}_{{I}_{p}} - {σ}_{p} {\tilde{W}}_{ϒ}^{T} {\hat{W}}_{ϒ} - {γ}_{{c}_{p}} {\tilde{W}}_{{c}_{p}}^{T} {Φ}_{{I}_{p}}^{T} {ℏ}_{f} {Ω}_{ff} {Φ}_{{I}_{p}} {\hat{W}}_{{c}_{p}} - {\tilde{W}}_{{a}_{p}}^{T} {Φ}_{{I}_{p}}^{T} {ℏ}_{f} {Ω}_{ff} {Φ}_{{I}_{p}} \times ( {γ}_{{a}_{p}} ( {\hat{W}}_{{a}_{p}} - {\hat{W}}_{{c}_{p}} ) + {γ}_{{c}_{p}} {\hat{W}}_{{c}_{p}} ) \qquad ( 60 )$$

By utilizing Young's inequality, we have:

$$\begin{matrix}{e}_{f}^{T} {ϵ}_{ϒ} & \leq \frac{1}{2} {e}_{f}^{T} {e}_{f} + \frac{1}{2} {ϵ}_{ϒ}^{T} {ϵ}_{ϒ} \\ {e}_{f}^{T} {z}_{f} & \leq \frac{1}{2} {e}_{f}^{T} {e}_{f} + \frac{1}{2} {z}_{f}^{T} {z}_{f} \\ - \frac{1}{2} {e}_{f}^{T} {\hat{W}}_{{a}_{p}}^{T} {Φ}_{{I}_{p}} & \leq \frac{1}{4} {e}_{f}^{T} {e}_{f} + \frac{1}{4} {\hat{W}}_{{a}_{p}}^{T} {Φ}_{{I}_{p}}^{T} {Φ}_{{I}_{p}} {\hat{W}}_{{a}_{p}}\end{matrix} \qquad ( 61 )$$

Substituting the Young's inequality (61) into (60) gives:

$${\dot{L}}_{1} = - {e}_{f} ( {K}_{p} - 1.25 ) {e}_{f} - {σ}_{p} {\tilde{W}}_{ϒ}^{T} {\hat{W}}_{ϒ} - {γ}_{{c}_{p}} {\tilde{W}}_{{c}_{p}}^{T} {Φ}_{{I}_{p}}^{T} {Φ}_{{I}_{p}} {\hat{W}}_{{c}_{p}} - {γ}_{{a}_{p}} {\tilde{W}}_{{a}_{p}}^{T} {Φ}_{{I}_{p}}^{T} {Φ}_{{I}_{p}} {\hat{W}}_{{a}_{p}} + ( {γ}_{{a}_{p}} - {γ}_{{a}_{c}} ) {\tilde{W}}_{{a}_{p}}^{T} {Φ}_{{I}_{p}}^{T} {Φ}_{{I}_{p}} {\hat{W}}_{{c}_{p}} + \frac{1}{4} {\hat{W}}_{{a}_{p}}^{T} {Φ}_{{I}_{p}}^{T} {Φ}_{{I}_{p}} {\hat{W}}_{{a}_{p}} + \frac{1}{2} {ϵ}_{ϒ}^{T} ϵϒ + \frac{1}{2} {z}_{f}^{T} {z}_{f} \qquad ( 62 )$$

Noting that

$${\tilde{W}}_{ϒ} = {\hat{W}}_{ϒ} - {W}_{Υ}^{*} , {\tilde{W}}_{{a}_{p}} = {\hat{W}}_{{a}_{p}} - {W}_{{I}_{p}}^{*} , and {\tilde{W}}_{{c}_{p}} = {\hat{W}}_{{c}_{p}} - {W}_{{I}_{p}}^{*} ,$$

the following facts are valid:

$${\tilde{W}}_{ϒ}^{T} {\hat{W}}_{ϒ} = \frac{1}{2} {\tilde{W}}_{ϒ}^{T} {\tilde{W}}_{ϒ} + \frac{1}{2} {\hat{W}}_{ϒ}^{T} {\hat{W}}_{ϒ} - \frac{1}{2} {W}_{ϒ}^{* T} {W}_{ϒ}^{*} \qquad ( 63 )$$

$${\tilde{W}}_{{c}_{p}}^{T} {Φ}_{{I}_{p}}^{T} {Φ}_{{I}_{p}} {\hat{W}}_{{c}_{p}} = \frac{1}{2} {\tilde{W}}_{{c}_{p}}^{T} {Φ}_{{I}_{p}}^{T} {Φ}_{{I}_{p}} {\tilde{W}}_{{c}_{p}} + \frac{1}{2} {\hat{W}}_{{c}_{p}}^{T} {Φ}_{{I}_{p}}^{T} {Φ}_{{I}_{p}} {\hat{W}}_{{c}_{p}} - \frac{1}{2} {W}_{{I}_{p}}^{* T} {Φ}_{{I}_{p}}^{T} {Φ}_{{I}_{p}} {W}_{{I}_{p}}^{*} \qquad ( 64 )$$

$${\tilde{W}}_{{a}_{p}}^{T} {Φ}_{{I}_{p}}^{T} {Φ}_{{I}_{p}} {\hat{W}}_{{a}_{p}} = \frac{1}{2} {\tilde{W}}_{{a}_{p}}^{T} {Φ}_{{I}_{p}}^{T} {Φ}_{{I}_{p}} {\tilde{W}}_{{a}_{p}} + \frac{1}{2} {\hat{W}}_{{a}_{p}}^{T} {Φ}_{{I}_{p}}^{T} {Φ}_{{I}_{p}} {\hat{W}}_{{a}_{p}} - \frac{1}{2} {W}_{{I}_{p}}^{* T} {Φ}_{{I}_{p}}^{T} {Φ}_{{I}_{p}} {W}_{{I}_{p}}^{*} \qquad ( 65 )$$

Combining (63)-(65) with (62) yields:

$${\dot{L}}_{1} = - {e}_{f} ( {K}_{p} - 1.25 ) {e}_{f} - \frac{{σ}_{p}}{2} {\tilde{W}}_{ϒ}^{T} {\tilde{W}}_{ϒ} - \frac{{γ}_{{c}_{p}}}{2} {\tilde{W}}_{{c}_{p}}^{T} {Φ}_{{I}_{p}}^{T} {Φ}_{{I}_{p}} {\tilde{W}}_{{c}_{p}} - \frac{{γ}_{{a}_{p}}}{2} {\tilde{W}}_{{a}_{p}}^{T} {Φ}_{{I}_{p}}^{T} {Φ}_{{I}_{p}} {\tilde{W}}_{{a}_{p}} + ( {γ}_{{a}_{p}} - {γ}_{{a}_{c}} ) {\tilde{W}}_{{a}_{p}}^{T} {Φ}_{{I}_{p}}^{T} {Φ}_{{I}_{p}} {\hat{W}}_{{c}_{p}} - \frac{{γ}_{{c}_{p}}}{2} {\hat{W}}_{{c}_{p}}^{T} {Φ}_{{I}_{p}}^{T} {Φ}_{{I}_{p}} {\hat{W}}_{{c}_{p}} - ( \frac{{γ}_{{a}_{p}}}{2} - \frac{1}{4} ) {\hat{W}}_{{a}_{p}}^{T} {Φ}_{{I}_{p}}^{T} {Φ}_{{I}_{p}} {\hat{W}}_{{a}_{p}} + ( \frac{{γ}_{{a}_{p}}}{2} + \frac{{γ}_{{c}_{p}}}{2} ) {W}_{{I}_{p}}^{* T} {Φ}_{{I}_{p}}^{T} {Φ}_{{I}_{p}} {W}_{{I}_{p}}^{*} + \frac{{σ}_{p}}{2} {W}_{ϒ}^{* T} {W}_{ϒ}^{*} + \frac{1}{2} {ϵ}_{ϒ}^{T} {ϵ}_{ϒ} + \frac{1}{2} {z}_{f}^{T} {z}_{f} \qquad ( 66 )$$

According to Young's inequality, the following relationship is valid

$${\tilde{W}}_{{a}_{p}}^{T} {Φ}_{{I}_{p}}^{T} {Φ}_{{I}_{p}} {\hat{W}}_{{c}_{p}} = \frac{1}{2} {\tilde{W}}_{{a}_{p}}^{T} {Φ}_{{I}_{p}}^{T} {Φ}_{{I}_{p}} {\tilde{W}}_{{a}_{p}} + \frac{1}{2} {\hat{W}}_{{c}_{p}}^{T} {Φ}_{{I}_{p}}^{T} {Φ}_{{I}_{p}} {\hat{W}}_{{c}_{p}} \qquad ( 67 )$$

then

$${\dot{L}}_{1} = - {e}_{f} ( {K}_{p} - 1.25 ) {e}_{f} - \frac{{σ}_{p}}{2} {\tilde{W}}_{ϒ}^{T} {\tilde{W}}_{ϒ} - \frac{{γ}_{{c}_{p}}}{2} {\tilde{W}}_{{c}_{p}}^{T} {Φ}_{{I}_{p}}^{T} {Φ}_{{I}_{p}} {\tilde{W}}_{{c}_{p}} - \frac{{γ}_{{c}_{p}}}{2} {\tilde{W}}_{{a}_{p}}^{T} {Φ}_{{I}_{p}}^{T} {Φ}_{{I}_{p}} {\tilde{W}}_{{a}_{p}} - ( {γ}_{{c}_{p}} - \frac{{γ}_{{a}_{p}}}{2} ) {\hat{W}}_{{c}_{p}}^{T} {Φ}_{{I}_{p}}^{T} {Φ}_{{I}_{p}} {\hat{W}}_{{c}_{p}} - ( \frac{{γ}_{{a}_{p}}}{2} - \frac{1}{4} ) {\hat{W}}_{{a}_{p}}^{T} {Φ}_{{I}_{p}}^{T} {Φ}_{{I}_{p}} {\hat{W}}_{{a}_{p}} + ( \frac{{γ}_{{a}_{p}}}{2} + \frac{{γ}_{{c}_{p}}}{2} ) {W}_{{I}_{p}}^{* T} {Φ}_{{I}_{p}}^{T} {Φ}_{{I}_{p}} {W}_{{I}_{p}}^{*} + \frac{{σ}_{p}}{2} {W}_{ϒ}^{* T} {W}_{ϒ}^{*} + \frac{1}{2} {ϵ}_{ϒ}^{T} {ϵ}_{ϒ} + \frac{1}{2} {z}_{f}^{T} {z}_{f} \qquad ( 68 )$$

The parameters Kₚ, γ_{c}_{ₚ}, and γₐ_{ₚ} are selected such that:

$${K}_{p} > 1.25 , {γ}_{{a}_{p}} > \frac{1}{2} , {γ}_{{a}_{p}} > {γ}_{{c}_{p}} > \frac{{γ}_{{a}_{p}}}{2} \qquad ( 69 )$$

Therefore, based on the selected parameters, (68) becomes:

$${\dot{L}}_{1} = - {e}_{f} ( {K}_{p} - 2 ) {e}_{f} - \frac{{σ}_{p}}{2} {\tilde{W}}_{ϒ}^{T} {\tilde{W}}_{ϒ} - \frac{{γ}_{{c}_{p}}}{2} {\tilde{W}}_{{c}_{p}}^{T} {Φ}_{{I}_{p}}^{T} {Φ}_{{I}_{p}} {\tilde{W}}_{{c}_{p}} - \frac{{γ}_{{c}_{p}}}{2} {\tilde{W}}_{{a}_{p}}^{T} {Φ}_{{I}_{p}}^{T} {Φ}_{{I}_{p}} {\tilde{W}}_{{a}_{p}} \frac{1}{2} {z}_{f}^{T} {z}_{f} + {𝒟}_{1} \qquad ( 70 )$$

where

$${𝒟}_{1} = ( \frac{{γ}_{{a}_{p}}}{2} + \frac{{γ}_{{c}_{p}}}{2} ) {W}_{{I}_{p}}^{* T} {Φ}_{{I}_{p}}^{T} {Φ}_{{I}_{p}} {W}_{{I}_{p}}^{*} + \frac{{σ}_{p}}{2} {W}_{ϒ}^{* T} {W}_{ϒ}^{*} + \frac{1}{2} {ϵ}_{ϒ}^{T} {ϵ}_{ϒ} ,$$

which satisfies [symbol] ≤ [symbol] and [symbol] >0 is a constant. After designing the optimized virtual control

$${α}_{f}^{*} ,$$

the next step is designing the actual control u. Equation (33) can be rewritten with the approximate

$${\hat{α}}_{f}^{*}$$

as follows:

$${\dot{z}}_{f} = F + u - {\dot{\hat{α}}}_{f}^{*} \qquad ( 71 )$$

A performance index function associated with z_{f} and u is defined as follows:

$${I}_{v} ( {z}_{f} ) = {\int }_{t}^{∞} {r}_{v} ( {z}_{f} ( τ ) , u ( τ ) ) d τ \qquad ( 72 )$$

where

$${r}_{v} ( {z}_{f} , u ) = {z}_{f}^{T} {z}_{f} + {u}^{T} u$$

is the cost function. Let u* be the optimal control and the corresponding optimal performance index I(z_{f})* is constructed as:

$$\begin{matrix}{I}_{v}^{*} ( {z}_{f} ) = {min}_{u ∈ Π} ( {\int }_{t}^{∞} {r}_{v} ( {z}_{f} ( τ ) , u ( τ ) ) d τ ) \\ = {\int }_{t}^{∞} ( {z}_{f}^{T} {z}_{f} + {u}^{* T} {u}^{*} ) d τ\end{matrix} \qquad ( 73 )$$

where Π is the set of admissible control inputs. The HJB equation associated with (73) is given by:

$${H}_{v} ( {z}_{f} , {u}^{*} , \frac{\partial {I}_{v}^{*}}{\partial {z}_{f}} ) = {r}_{v} ( {z}_{f} , {u}^{*} ) + \frac{\partial {I}_{v}^{*}}{\partial {z}_{f}} {\dot{z}}_{f} = {z}_{f}^{T} {z}_{f} + {u}^{* T} {u}^{*} + \frac{\partial {I}_{v}^{*}}{\partial {z}_{f}} ( F + u - {\dot{\hat{α}}}_{f}^{*} ) \qquad ( 74 )$$

Following the same procedure as step 1, solving

$$\partial {H}_{v} ( {z}_{f} , {u}^{*} , \frac{\partial {I}_{v}^{*}}{\partial {z}_{f}} ) / \partial {u}^{*} = 0$$

gives

$${u}^{*} = - \frac{1}{2} \frac{\partial {I}_{v}^{*} ( {z}_{f} )}{\partial {z}_{f}} \qquad ( 75 )$$

To realize the control objective, the term

$$\frac{\partial {I}_{v}^{*}}{\partial {z}_{f}}$$

is expressed as follows:

$$\frac{\partial {I}_{v}^{*} ( {z}_{f} )}{\partial {z}_{f}} = 2 {C}_{v} {e}_{f} + 2 {K}_{v} {z}_{f} + 2 F + {I}_{v}^{0} \qquad ( 76 )$$

where

$${I}_{v}^{0} = - 2 {C}_{v} {e}_{f} - 2 {K}_{1} {z}_{f} - 2 F + \frac{\partial {I}_{v}^{*} ( {z}_{f} )}{\partial {z}_{f}} .$$

Inserting (76) into (75) gives:

$${u}^{*} = - {C}_{v} {e}_{f} - {K}_{v} {z}_{f} - F - \frac{1}{2} {I}_{v}^{0} \qquad ( 77 )$$

The unknown continuous functions F and

$${I}_{v}^{0}$$

can be approximately by RBFNNs as follows:

$$F = {W}_{F}^{* T} {Φ}_{F} ( {X}_{F} ) + {ϵ}_{F} ( {X}_{F} ) \qquad ( 78 )$$

$${I}_{v}^{0} = {W}_{{I}_{v}}^{* T} {Φ}_{{I}_{v}} ( {X}_{{I}_{v}} ) + {ϵ}_{{I}_{v}} ( {X}_{{I}_{v}} ) \qquad ( 79 )$$

where

$${W}_{F}^{*} and {W}_{{I}_{v}}^{*}$$

are the ideal weights, Φ_{F}(X_{F}) and Φ_{Iv}(X_{Iv}) are the vectors basis functions, and ϵ_{F}(X_{F}) and ϵ_{Iv}(X_{Iv}) are the RBFNN approximation errors.
Inserting (78) and (79) into (76) and (77), respectively gives:

$$\frac{\partial {I}_{v}^{*} ( {z}_{f} )}{\partial {z}_{f}} = 2 {C}_{v} {e}_{f} + 2 {K}_{1} {z}_{f} + 2 {W}_{F}^{* T} {Φ}_{F} ( {X}_{F} ) + {W}_{{I}_{v}}^{* T} {Φ}_{{I}_{v}} ( {X}_{{I}_{v}} ) + {ϵ}_{v} \qquad ( 80 )$$

$${u}^{*} = - {C}_{v} {e}_{f} - {K}_{v} {z}_{f} - {W}_{F}^{* T} {Φ}_{F} ( {X}_{F} ) - \frac{1}{2} {W}_{{I}_{v}}^{* T} {Φ}_{{I}_{v}} ( {X}_{{I}_{v}} ) + \frac{1}{2} {ϵ}_{v} \qquad ( 81 )$$

where ϵᵥ=2ϵ_{F}(X_{F})+ϵ_{Iv}(X_{Iv}).
The optimal control law (81) is unavailable since the weights

$${W}_{F}^{*} and {W}_{{I}_{v}}^{*}$$

are unknown. To obtain a usable optimized control, an RL architecture using the identifier, critic, and actor networks is constructed as:

$$\hat{F} = {\hat{W}}_{F}^{T} {Φ}_{F} ( {X}_{F} ) \qquad ( 82 )$$

$$\frac{\partial {I}_{v}^{*} ( {z}_{f} )}{\partial {z}_{f}} = 2 {C}_{v} {e}_{f} + 2 {K}_{1} {z}_{f} + 2 {\hat{W}}_{F}^{* T} {Φ}_{F} ( {X}_{F} ) + {\hat{W}}_{{c}_{v}}^{* T} {Φ}_{{I}_{v}} ( {X}_{{I}_{v}} ) \qquad ( 83 )$$

$${\hat{u}}^{*} = - {C}_{v} {e}_{f} - {K}_{v} {z}_{f} - {\hat{W}}_{F}^{* T} {Φ}_{F} ( {X}_{F} ) - \frac{1}{2} {\hat{W}}_{{a}_{v}}^{* T} {Φ}_{{I}_{v}} ( {X}_{{I}_{v}} ) \qquad ( 84 )$$

where

$${\hat{W}}_{F} , {\hat{W}}_{{c}_{v}}^{*} and {\hat{W}}_{{a}_{v}}^{*}$$

are the estimates of the identifier, critic, and actor weights, respectively, \hat{F} and

$$\frac{\partial {\hat{I}}_{v} ( {z}_{f} )}{\partial z f}$$

are the estimates of F and

$$\frac{\partial {I}_{v} ( z f )}{\partial z f} ,$$

respectively.
The RBFNN weights of the identifier, critic, and actor are updated by the following update laws:

$${\dot{\hat{W}}}_{F} = {Γ}_{v} ( {Φ}_{F} ( {X}_{F} ) {z}_{f} - {σ}_{v} {\hat{W}}_{F} ) \qquad ( 85 )$$

$${\dot{\hat{W}}}_{{c}_{v}} = - {γ}_{{c}_{v}} {Φ}_{{I}_{v}}^{T} {Φ}_{{I}_{v}} {\hat{W}}_{{c}_{v}} \qquad ( 86 )$$

$${\dot{\hat{W}}}_{{a}_{v}} = - {Φ}_{{I}_{v}}^{T} {Φ}_{{I}_{v}} ( {γ}_{{a}_{v}} ( {\hat{W}}_{{a}_{v}} - {\hat{W}}_{{c}_{v}} ) + {γ}_{{c}_{v}} {\hat{W}}_{{c}_{v}} ) \qquad ( 87 )$$

where Γᵥ is a positive-definite matrix, γₐ_{ᵥ}>0 and γ_{c}_{ᵥ}>0 are design constants, and σᵥ>0 is a small constant.
A Lyapunov candidate function is selected for the zᵥ₋ subsystem as:

$${L}_{2} = {L}_{1} + \frac{1}{2} {z}_{f}^{T} {z}_{f} + \frac{1}{2} {\tilde{W}}_{F}^{T} {Γ}_{v}^{- 1} {\tilde{W}}_{F} + \frac{1}{2} {\tilde{W}}_{{c}_{v}}^{T} {\tilde{W}}_{{c}_{v}} + \frac{1}{2} {\tilde{W}}_{{a}_{v}}^{T} {\tilde{W}}_{{a}_{v}} \qquad ( 88 )$$

where

$${\tilde{W}}_{F} = {\hat{W}}_{F} - {W}_{F}^{*} , {\tilde{W}}_{{a}_{v}} = {\hat{W}}_{{a}_{v}} - {W}_{{I}_{v}}^{*} , and {\tilde{W}}_{{c}_{v}} = {\hat{W}}_{{c}_{v}} - {W}_{{I}_{v}}^{*}$$

are the RBFNN weight errors for the identifier, actor, and critic networks, respectively.
Taking the time derivative of L₂ and using (85), (86), and (87), one has:

$${\dot{L}}_{2} = {\dot{L}}_{1} + {z}_{f}^{T} ( F + {\hat{u}}^{*} - {\dot{\hat{α}}}_{f}^{*} ) + {\tilde{W}}_{F}^{T} ( {Φ}_{F}^{T} {z}_{f} - {σ}_{v} {\hat{W}}_{F} ) - {γ}_{{c}_{v}} {\hat{W}}_{{c}_{v}}^{T} {Φ}_{{I}_{v}}^{T} {Φ}_{{I}_{v}} {\hat{W}}_{{c}_{v}} - {\tilde{W}}_{{a}_{v}}^{T} {Φ}_{{I}_{v}}^{T} {Φ}_{{I}_{v}} ( {γ}_{{a}_{v}} ( {\hat{W}}_{{a}_{v}} - {\hat{W}}_{{c}_{v}} ) + {γ}_{{c}_{v}} {\hat{W}}_{{c}_{v}} ) \qquad ( 89 )$$

Inserting (82) and (84) into (89), one gets:

$${\dot{L}}_{2} = {\dot{L}}_{1} + {z}_{f} [ - {C}_{v} {e}_{f} - {K}_{v} {z}_{f} - \frac{1}{2} {\tilde{W}}_{{a}_{v}}^{T} {Φ}_{{I}_{v}} ( {X}_{{I}_{v}} ) - {\tilde{W}}_{F}^{T} {Φ}_{F} ( {X}_{F} ) + {ϵ}_{F} - {\dot{\hat{α}}}_{f}^{*} ] + {\tilde{W}}_{F}^{T} ( {Φ}_{F}^{T} {z}_{f} - {σ}_{v} {\hat{W}}_{F} ) - {γ}_{{c}_{v}} {\hat{W}}_{{c}_{v}}^{T} {Φ}_{{I}_{v}}^{T} {Φ}_{{I}_{v}} {\hat{W}}_{{c}_{v}} - {\tilde{W}}_{{a}_{v}}^{T} {Φ}_{{I}_{v}}^{T} {Φ}_{{I}_{v}} ( {γ}_{{a}_{v}} ( {\hat{W}}_{{a}_{v}} - {\hat{W}}_{{c}_{v}} ) + {γ}_{{c}_{v}} {\hat{W}}_{{c}_{v}} ) \qquad ( 90 )$$

Evaluating (90) yields:

$${\dot{L}}_{2} = {\dot{L}}_{1} - {z}_{f} {C}_{v} {e}_{f} - {z}_{f} {K}_{v} {z}_{f} + {z}_{f}^{T} {ϵ}_{F} - {z}_{f}^{T} {\dot{\hat{α}}}_{f}^{*} - \frac{1}{2} {z}_{f}^{T} {\hat{W}}_{{a}_{v}} {Φ}_{{I}_{v}} - {σ}_{v} {\tilde{W}}_{F}^{T} {\hat{W}}_{F} - {γ}_{{c}_{v}} {\tilde{W}}_{{c}_{v}}^{T} {Φ}_{{I}_{v}}^{T} {Φ}_{{I}_{v}} {\hat{W}}_{{c}_{v}} - {\tilde{W}}_{{a}_{v}}^{T} {Φ}_{{I}_{v}}^{T} {Φ}_{{I}_{v}} ( {γ}_{{a}_{v}} ( {\hat{W}}_{{a}_{v}} - {\hat{W}}_{{c}_{v}} ) + {γ}_{{c}_{v}} {\hat{W}}_{{c}_{v}} ) \qquad ( 91 )$$

From Young's inequality, one gets:

$$\begin{matrix}{z}_{f} {ϵ}_{F} & \leq \frac{1}{2} {z}_{f}^{T} {z}_{f} + \frac{1}{2} {ϵ}_{F}^{T} {ϵ}_{F} \\ - {z}_{f}^{T} {\dot{\hat{α}}}_{f}^{*} & \leq \frac{1}{2} {z}_{f}^{T} {z}_{f} + \frac{1}{2} {\dot{\hat{α}}}_{f}^{* T} {\dot{\hat{α}}}_{f}^{*} \\ - {z}_{f} {C}_{v} {e}_{f} & \leq \frac{1}{2} {z}_{f}^{T} {C}_{v} {z}_{f} + \frac{1}{2} {e}_{F}^{T} {C}_{v} {e}_{F} \\ - \frac{1}{2} {z}_{f}^{T} {\hat{W}}_{{a}_{v}}^{T} {Φ}_{{I}_{v}} & \leq \frac{1}{4} {z}_{f}^{T} {z}_{f} + \frac{1}{4} {\hat{W}}_{{a}_{v}}^{T} {Φ}_{{I}_{v}}^{T} {Φ}_{{I}_{v}} {\hat{W}}_{{a}_{v}}\end{matrix} \qquad ( 92 )$$

Substituting the Young's inequality (92) into (91) yields:

$${\dot{L}}_{2} \leq {\dot{L}}_{1} + \frac{1}{2} {e}_{f}^{T} {C}_{v} {e}_{f} - {z}_{f} ( {K}_{v} - {C}_{v} / 2 - 1.75 ) {z}_{f} - {σ}_{v} {\tilde{W}}_{F}^{T} {\hat{W}}_{F} - {γ}_{{c}_{v}} {\tilde{W}}_{{c}_{v}}^{T} {Φ}_{{I}_{v}}^{T} {Φ}_{{I}_{v}} {\hat{W}}_{{c}_{v}} - {γ}_{{a}_{v}} {\tilde{W}}_{{a}_{v}}^{T} {Φ}_{{I}_{v}}^{T} {Φ}_{{I}_{v}} {\hat{W}}_{{a}_{v}} + ( {γ}_{{a}_{v}} - {γ}_{{a}_{c}} ) {\tilde{W}}_{{a}_{v}}^{T} {Φ}_{{I}_{v}}^{T} {Φ}_{{I}_{v}} {\hat{W}}_{{c}_{v}} + \frac{1}{4} {\hat{W}}_{{a}_{v}}^{T} {Φ}_{{I}_{v}}^{T} {Φ}_{{I}_{v}} {\hat{W}}_{{a}_{v}} + \frac{1}{2} {ϵ}_{F}^{T} {ϵ}_{F} + \frac{1}{2} {\dot{\hat{α}}}_{f}^{* T} {\dot{\hat{α}}}_{f}^{*} \qquad ( 93 )$$

### Using

$${\tilde{W}}_{F} = {\hat{W}}_{F} - {W}_{F}^{*} , {\tilde{W}}_{{a}_{v}} = {\hat{W}}_{{a}_{v}} - {W}_{{I}_{v}}^{*} , and {\tilde{W}}_{{c}_{v}} = {\hat{W}}_{{c}_{v}} - {W}_{{I}_{v}}^{*} ,$$

the following facts are valid:

$${\tilde{W}}_{F}^{T} {\hat{W}}_{F} = \frac{1}{2} {\tilde{W}}_{F}^{T} {\tilde{W}}_{F} + \frac{1}{2} {\hat{W}}_{F}^{T} {\hat{W}}_{F} - \frac{1}{2} {W}_{F}^{* T} {W}_{F}^{*} \qquad ( 94 )$$

$${\tilde{W}}_{{c}_{v}}^{T} {Φ}_{{I}_{v}}^{T} {Φ}_{{I}_{v}} {\hat{W}}_{{c}_{v}} = \frac{1}{2} {\tilde{W}}_{{c}_{v}}^{T} {Φ}_{{I}_{v}}^{T} {Φ}_{{I}_{v}} {\tilde{W}}_{{c}_{v}} + \frac{1}{2} {\hat{W}}_{{c}_{v}}^{T} {Φ}_{{I}_{v}}^{T} {Φ}_{{I}_{v}} {\hat{W}}_{{c}_{v}} - \frac{1}{2} {W}_{{I}_{v}}^{* T} {Φ}_{{I}_{v}}^{T} {Φ}_{{I}_{v}} {W}_{{I}_{v}}^{*} \qquad ( 95 )$$

$${\tilde{W}}_{{a}_{v}}^{T} {Φ}_{{I}_{v}}^{T} {Φ}_{{I}_{v}} {\hat{W}}_{{a}_{v}} = \frac{1}{2} {\tilde{W}}_{{a}_{v}}^{T} {Φ}_{{I}_{v}}^{T} {Φ}_{{I}_{v}} {\tilde{W}}_{{a}_{v}} + \frac{1}{2} {\hat{W}}_{{a}_{v}}^{T} {Φ}_{{I}_{v}}^{T} {Φ}_{{I}_{v}} {\hat{W}}_{{a}_{v}} - \frac{1}{2} {W}_{{I}_{v}}^{* T} {Φ}_{{I}_{v}}^{T} {Φ}_{{I}_{v}} {W}_{{I}_{v}}^{*} \qquad ( 96 )$$

Combining (94)-(96) with (93) yields:

$${\dot{L}}_{2} \leq {\dot{L}}_{1} + \frac{1}{2} {e}_{f}^{T} {C}_{v} {e}_{f} - {z}_{f} ( {K}_{v} - {C}_{v} / 2 - 1.75 ) {z}_{f} - \frac{{σ}_{v}}{2} {\tilde{W}}_{F}^{T} {\tilde{W}}_{F} - \frac{{γ}_{{c}_{v}}}{2} {\tilde{W}}_{{c}_{v}}^{T} {Φ}_{{I}_{v}}^{T} {Φ}_{{I}_{v}} {\tilde{W}}_{{c}_{v}} - \frac{{γ}_{{a}_{v}}}{2} {\tilde{W}}_{{a}_{v}}^{T} {Φ}_{{I}_{v}}^{T} {Φ}_{{I}_{v}} {\tilde{W}}_{{a}_{v}} + ( {γ}_{{a}_{v}} - {γ}_{{a}_{c}} ) {\tilde{W}}_{{a}_{v}}^{T} {Φ}_{{I}_{v}}^{T} {Φ}_{{I}_{v}} {\hat{W}}_{{c}_{v}} - \frac{{γ}_{{c}_{v}}}{2} {\hat{W}}_{{a}_{v}}^{T} {Φ}_{{I}_{v}}^{T} {Φ}_{{I}_{v}} {\hat{W}}_{{a}_{v}} - ( \frac{{γ}_{{a}_{v}}}{2} - \frac{1}{4} ) {\hat{W}}_{{a}_{v}}^{T} {Φ}_{{I}_{v}}^{T} {Φ}_{{I}_{v}} {\hat{W}}_{{c}_{v}} + ( \frac{{γ}_{{a}_{v}}}{2} + \frac{{γ}_{{c}_{v}}}{2} ) {W}_{{I}_{v}}^{* T} {Φ}_{{I}_{v}}^{T} {Φ}_{{I}_{v}} {W}_{{I}_{v}}^{*} + \frac{{σ}_{v}}{2} {W}_{F}^{* T} {Φ}_{F}^{*} + \frac{1}{2} {ϵ}_{F}^{T} {ϵ}_{F} + \frac{1}{2} {{α}^{\dot{\hat{}}}}_{f}^{* T} {{α}^{\dot{\hat{}}}}_{f}^{*} \qquad ( 97 )$$

Based on Young's inequality, one gets.

$${\tilde{W}}_{{a}_{v}}^{T} {Φ}_{{I}_{v}}^{T} {Φ}_{{I}_{v}} {\hat{W}}_{{c}_{v}} = \frac{1}{2} {\tilde{W}}_{{a}_{v}}^{T} {Φ}_{{I}_{v}}^{T} {Φ}_{{I}_{v}} {\tilde{W}}_{{a}_{v}} + \frac{1}{2} {\hat{W}}_{{c}_{v}}^{T} {Φ}_{{I}_{v}}^{T} {Φ}_{{I}_{v}} {\hat{W}}_{{c}_{v}} \qquad ( 98 )$$

By utilizing (98), one gets:

$${\dot{L}}_{2} \leq {e}_{f} {ℏ}_{f} {Ω}_{ff} ( {K}_{p} - {C}_{v} / 2 - 1.25 ) {e}_{f} - \frac{{γ}_{{c}_{p}}}{2} {\tilde{W}}_{{c}_{p}}^{T} {Φ}_{{I}_{p}}^{T} {Φ}_{{I}_{p}} {\tilde{W}}_{{c}_{p}} - \frac{{σ}_{p}}{2} {\tilde{W}}_{ϒ}^{T} {\tilde{W}}_{ϒ} - \frac{{γ}_{{c}_{p}}}{2} {\tilde{W}}_{{a}_{p}}^{T} {Φ}_{{I}_{p}}^{T} {Φ}_{{I}_{p}} {\tilde{W}}_{{a}_{p}} - {z}_{f}^{T} ( {K}_{v} - {C}_{v} / 2 - 1.75 ) {z}_{f} - \frac{{γ}_{{c}_{v}}}{2} {\tilde{W}}_{{c}_{v}}^{T} {Φ}_{{I}_{v}}^{T} {Φ}_{{I}_{v}} {\tilde{W}}_{{c}_{v}} - \frac{{γ}_{{c}_{v}}}{2} {\tilde{W}}_{{a}_{v}}^{T} {Φ}_{{I}_{v}}^{T} {Φ}_{{I}_{v}} {\tilde{W}}_{{a}_{v}} - \frac{{σ}_{v}}{2} {\tilde{W}}_{F}^{T} {\tilde{W}}_{F} - ( {γ}_{{c}_{v}} - \frac{{γ}_{{a}_{v}}}{2} ) {\hat{W}}_{{c}_{v}}^{T} {Φ}_{{I}_{v}}^{T} {Φ}_{{I}_{v}} {\hat{W}}_{{c}_{v}} - ( \frac{{γ}_{{a}_{v}}}{2} - \frac{1}{4} ) {\hat{W}}_{{a}_{v}}^{T} {Φ}_{{I}_{v}}^{T} {Φ}_{{I}_{v}} {\hat{W}}_{{a}_{v}} + ( \frac{{γ}_{{a}_{v}}}{2} + \frac{{γ}_{{c}_{v}}}{2} ) {W}_{{I}_{v}}^{* T} {Φ}_{{I}_{v}}^{T} {Φ}_{{I}_{v}} {W}_{{I}_{v}}^{*} + \frac{{σ}_{v}}{2} {W}_{F}^{* T} {W}_{F}^{*} + \frac{1}{2} {ϵ}_{F}^{T} {ϵ}_{F} + \frac{1}{2} {{α}^{\dot{\hat{}}}}_{f}^{* T} {{α}^{\dot{\hat{}}}}_{f}^{*} + {\overline{𝒟}}_{1} \qquad ( 99 )$$

The parameters Cᵥ, Kᵥ, γ_{c}_{ᵥ}, and γₐ_{ᵥ} are selected such that

$$\begin{matrix}{C}_{v} > 2.5 , {K}_{v} > {C}_{v} , {K}_{v} - {C}_{v} > 3.5 , \\ {γ}_{{a}_{v}} > \frac{1}{2} , {γ}_{{a}_{v}} > {γ}_{{c}_{v}} > \frac{{γ}_{{a}_{v}}}{2}\end{matrix}$$

Therefore, based on the selected parameters, (99) becomes:

$${\dot{L}}_{2} \leq - {e}_{f}^{T} ( {K}_{p} - {C}_{v} / 2 - 1.25 ) {e}_{f} - \frac{{γ}_{{c}_{p}}}{2} {\tilde{W}}_{{c}_{p}}^{T} {Φ}_{{I}_{p}}^{T} {Φ}_{{I}_{p}} {\tilde{W}}_{{c}_{p}} - \frac{{σ}_{p}}{2} {\tilde{W}}_{ϒ}^{T} {\tilde{W}}_{ϒ} - \frac{{γ}_{{c}_{p}}}{2} {\tilde{W}}_{{a}_{p}}^{T} {Φ}_{{I}_{p}}^{T} {Φ}_{{I}_{p}} {\tilde{W}}_{{c}_{p}} - {z}_{f}^{T} ( {K}_{v} - {C}_{v} / 2 - 1.75 ) {z}_{f} - \frac{{σ}_{v}}{2} {\tilde{W}}_{F}^{T} {\tilde{W}}_{F} - \frac{{γ}_{{c}_{v}}}{2} {\tilde{W}}_{{c}_{v}}^{T} {Φ}_{{I}_{v}}^{T} {Φ}_{{I}_{v}} {\tilde{W}}_{{c}_{v}} - \frac{{γ}_{{c}_{v}}}{2} {\tilde{W}}_{{a}_{v}}^{T} {Φ}_{{I}_{v}}^{T} {Φ}_{{I}_{v}} {\tilde{W}}_{{a}_{v}} + {𝒟}_{2} \qquad ( 100 )$$

where

$${𝒟}_{2} = ( \frac{{γ}_{{a}_{v}}}{2} + \frac{{γ}_{{c}_{v}}}{2} ) {W}_{{I}_{v}}^{* T} {Φ}_{{I}_{v}}^{T} {Φ}_{{I}_{v}} {W}_{{I}_{v}}^{*} + \frac{{σ}_{v}}{2} {W}_{F}^{* T} {W}_{F}^{*} + \frac{1}{2} {ϵ}_{F}^{T} {ϵ}_{F} + \frac{1}{2} {{α}^{\dot{\hat{}}}}_{f}^{* T} {{α}^{\dot{\hat{}}}}_{f}^{*} + {\overline{𝒟}}_{1} ,$$

which satisfies [symbol] ≤ [symbol] , and [symbol] >0 is a constant.
The inequality (100) can be rewritten as:

$${\dot{L}}_{2} \leq - {λ}_{p}^{min} {e}_{f}^{T} {e}_{f} - \frac{{σ}_{p}}{2 {λ}_{{Γ}_{p}^{- 1}}^{max}} {\tilde{W}}_{ϒ}^{T} {Γ}_{v}^{- 1} {\tilde{W}}_{ϒ} - \frac{{γ}_{{c}_{p}}}{2} {λ}_{{I}_{p}}^{min} {\tilde{W}}_{{c}_{p}}^{T} {\tilde{W}}_{{c}_{p}} - \frac{{γ}_{{c}_{p}}}{2} {λ}_{{I}_{p}}^{min} {\tilde{W}}_{{a}_{p}}^{T} {\tilde{W}}_{{a}_{p}} - {λ}_{{I}_{v}}^{min} {z}_{f}^{T} {z}_{f} - \frac{{σ}_{v}}{2 {λ}_{{Γ}_{v}^{- 1}}^{max}} {\tilde{W}}_{F}^{T} {Γ}_{v}^{- 1} {\tilde{W}}_{F} - \frac{{γ}_{{c}_{v}}}{2} {λ}_{{I}_{v}}^{min} {\tilde{W}}_{{c}_{v}}^{T} {\tilde{W}}_{{c}_{v}} - \frac{{γ}_{{c}_{v}}}{2} {λ}_{{I}_{v}}^{min} {\tilde{W}}_{{a}_{v}}^{T} {\tilde{W}}_{{a}_{v}} + {\overline{𝒟}}_{2} \qquad ( 101 )$$

where

$${λ}_{p}^{min}$$

is the minimum eigen value of (Kₚ−Cᵥ/2−1.25),

$${λ}_{v}^{min}$$

is the minimum Eigen value of (Kᵥ−Cᵥ/2−1.75),

$${λ}_{{I}_{p}}^{min}$$

is the minimum eigen value of Φ_{Ip}^{T}ℏ_{f}Ω_{ff}Φ_{Ip},

$${λ}_{{I}_{v}}^{min}$$

is the minimum eigen value of

$${Φ}_{{I}_{v}}^{T} {Φ}_{{I}_{v}} , {λ}_{{Γ}_{p}^{- 1}}^{{λ}_{p}}$$

is the maximum eigen value of

$${Γ}_{p}^{- 1} , and {λ}_{{Γ}_{v}^{- 1}}^{max}$$

is the maximum eigen value of

$${Γ}_{v}^{- 1}$$

From (101), one can obtain:

$${\dot{L}}_{2} \leq - {𝒟}_{3} {L}_{2} + {\overline{𝒟}}_{2} \qquad ( 102 )$$

### Where,

$${𝒟}_{3} = min \{ 2 {λ}_{p}^{min} , ( {σ}_{p} / {λ}_{{Γ}_{p}^{- 1}}^{max} ) , ( {γ}_{{c}_{p}} {λ}_{{I}_{p}}^{min} ) , ( {γ}_{{c}_{p}} {λ}_{{I}_{p}}^{min} ) , 2 {λ}_{v}^{min} , ( {σ}_{v} / {λ}_{{Γ}_{v}^{- 1}}^{max} ) , ( {γ}_{{c}_{v}} {λ}_{{I}_{v}}^{min} ) , ( {γ}_{{c}_{v}} {λ}_{{I}_{v}}^{min} ) \} .$$

In first theorem, considering the second-order nonlinear multiagent system (12) with unknown nonlinear dynamics under deception attacks and actuator faults. By using the prescribed performance function (22), the error dynamics (30) & (31), the reinforcement learning-based optimized virtual controller (47) and the optimized overall controller (84) with identifier update laws (45), (85), critics update laws (54), (86), and actors update laws (55), (87), then the tracking errors in the closed-loop system are bounded and the leader-follower affine formation maneuvers are realized.

Integrating both sides of (102) gives:

$${L}_{2} ( t ) \leq {e}^{- {𝒟}_{3} t} {L}_{2} ( 0 ) + \frac{{\overline{𝒟}}_{2}}{{𝒟}_{3}} ≡ ϱ \qquad ( 103 )$$

For all t≥Tₛ, the inequality (103) shows that all the error signals e_{f}, z_{f}, \tilde{W}ₐ_{ₚ}, \tilde{W}ₐ_{ᵥ}, \tilde{W}_{c}_{ₚ}, \tilde{W}_{c}_{ᵥ}, \tilde{W}_{γ}, and \tilde{W}_{F} are semiglobally bounded in finite settling time within a compact set defined by {L₂(t):∥L₂(t)∥≤ [symbol] }.

It is obvious that increasing [symbol] or decreasing [symbol] in (103) will aid in reducing [symbol] and subsequently makes the compact set smaller. This means that one may select the parameter [symbol] large enough to make e_{f}, z_{f}, \tilde{W}ₐ_{ₚ}, \tilde{W}ₐ_{ᵥ}, \tilde{W}_{c}_{ₚ}, \tilde{W}_{c}_{ᵥ}, \tilde{W}_{γ}, and \tilde{W}_{F} sufficiently small.

Compared to the work of affine formation maneuver control of linear multi-agent systems, this disclosure considers the issue of affine formation maneuver control of nonlinear multi-agent systems with preassigned performance. In addition, the disclosed technique is able to counter deception attacks and actuator faults.

Multiple adaptive laws are used to estimate the upper bounds of the

$${Λ}_{{p}_{i}} , {Λ}_{{v}_{i}} , {Λ}_{{p}_{i}} {Λ}_{{v}_{i}}^{- 1} , {\dot{Λ}}_{{p}_{i}} {Λ}_{{p}_{i}}^{- 1} , and {\dot{Λ}}_{{v}_{i}} {Λ}_{{v}_{i}}^{- 1} .$$

However, the attack signals are usually time-varying and adaptive laws can only estimate constants. By transforming the multi-agent system to the form in (28) and (29), neural networks approximate the lumped functions γ(p_{f}, v_{f}, Λₚ, Λᵥ) and F(p_{f}, v_{f}, Λₚ, Λᵥ, u) which have taken care of the time-varying attack signals and uncertain dynamics.

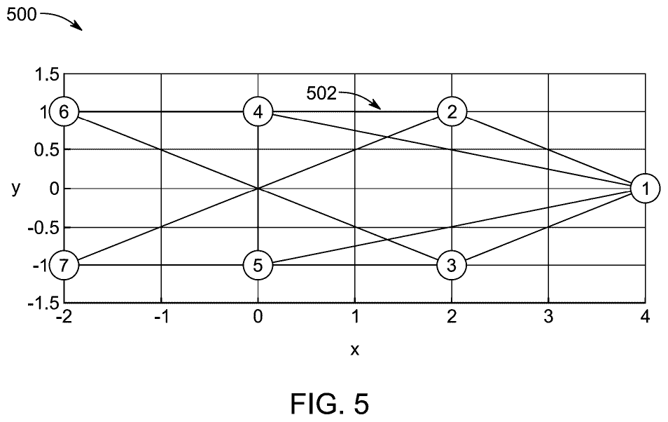

FIG. 5 illustrates a diagram 500 providing the leader-follower nominal formation topology 502 for a multi-agent system consisting of three leaders and four followers. The topology 502 demonstrates the interaction and connectivity between the agents during an affine formation maneuver. In this configuration, agents are connected by directed edges, showing the communication pathways that enable leader-follower control in the system.

The topology 502 consists of seven agents, where agents 1, 2, and 3 represent the leaders, while agents 4, 5, 6, and 7 are designated as the followers. The directed connections between the agents are depicted by lines, representing the nominal formation structure used to maintain coordination during the system's maneuvers.

Agent 1 is one of the leaders in the system, located on the right side of the topology. It is in communication with agents 2, 3, 4, 5, 6, and 7 via directed edges. These communication connections indicate that Agent 1 is configured for controlling the formation and influencing the motion of all followers, as well as the other leaders. Agent 1, in one implementation, serves as a primary controller in the leader-follower dynamic.

Agent 2 is another leader in the topology, in communication with agents 1, 4, 5, and 7. These connections demonstrate its role in assisting Agent 1 in maintaining the overall formation, controlling several followers and interacting with Agent 1. The connectivity of Agent 2 ensures that it contributes to the stability and coordination of the system during motion.

Agent 3, also a leader, is in communication with agents 1, 4, and 6. Similar to Agents 1 and 2, Agent 3 influences the motion of certain followers and maintains direct communication with Agent 1 to ensure proper coordination of the leader-follower structure. The connectivity of Agent 3 provides additional redundancy and robustness to the system's control scheme.

Agent 4 is a follower in communication with leaders 1, 2, and 3. The directed edges between Agent 4 and the leaders indicates reception of control signals and adjusting its position within the formation accordingly. Interactions of Agent 4 with all three leaders show its contribution in maintaining the geometric structure of the formation.

Agent 5, another follower, is in communication with leaders 1 and 2. The communication pathways between Agent 5 and the leaders ensure that it remains coordinated within the formation, following the control signals sent by Agents 1 and 2. The connections also indicate that Agent 5 is influenced by multiple leaders, contributing to the overall stability of the system.

Agent 6, a follower, is in communication with leaders 1 and 3. These connections indicate that Agent 6 is guided by the control inputs from both leaders to maintain its position and trajectory within the formation. The presence of multiple connections to leaders ensures that Agent 6 can respond appropriately to changes in the leader trajectories.

Agent 7, the final follower, is in communication with leaders 1 and 2. Like the other followers, Agent 7 receives control signals from multiple leaders, ensuring that it remains properly aligned within the formation during maneuvers of the system. The directed edges between Agent 7 and the leaders demonstrate its dependency on the leaders for maintaining its position in the topology.

A numerical example is illustrated herein to show the efficacy of the various embodiments of the present disclosure. The simulations are carried out on MATLAB/Simulink. The multi-agent system in this study consists of three leaders (Nₗ=3) and four followers (N_{f}=4) interacting over the nominal formation topology depicted in FIG. 5. The agents numbered 1,2, and 3 are the leaders while the remaining agents numbered 1,2,3, and 4 are the followers. The nominal configurations of the seven agents are q₁=[40], q₂=[2 1], q₃=[2 −1], q₄=[0 1], q₅=[0 −1], q₆=[−2 1] and q₇=[−2 −1], and

$$q = {[ {q}_{l}^{T} , {q}_{f}^{T} ]}^{T} ,$$

where

$${q}_{l} = {[ {q}_{1}^{T} , {q}_{2}^{T} , {q}_{3}^{T} ]}^{T} and {q}_{f} = {[ {q}_{4}^{T} , {q}_{5}^{T} , {q}_{6}^{T} , {q}_{7}^{T} ]}^{T} .$$

The target formation maneuvers of the leaders are described by the trajectories in (104). Various maneuvers of the leaders' nominal configurations can be obtained by manipulating A(t) and b(t).

$${p}_{i}^{′} ( t ) = A ( t ) {q}_{i} + b ( t ) , i = 1 , … , {N}_{l} \qquad ( 104 )$$

As par Assumption 1,

$${p}_{l} = {p}_{l}^{′} .$$

The motion of the followers is described by the following second-order nonlinear multi-agent systems.

$${\dot{p}}_{i} = {v}_{i} \qquad ( 105 )$$

$${\dot{v}}_{i} = [ \begin{matrix}{h}_{i 1} \\ {h}_{i 2}\end{matrix} ] + [ \begin{matrix}{g}_{i 1} & 0 \\ 0 & {g}_{i 2}\end{matrix} ] [ \begin{matrix}{\breve{u}}_{i 1} \\ {\breve{u}}_{i 2}\end{matrix} ] + [ \begin{matrix}{Φ}_{i 1} ( t ) \\ {Φ}_{i 2} ( t )\end{matrix} ]$$

$$i = {N}_{l} + 1 , … , {N}_{l} + {N}_{f}$$

with

$$[ \begin{matrix}{\breve{u}}_{i 1} \\ {\breve{u}}_{i 2}\end{matrix} ] = [ \begin{matrix}{m}_{i 1} & 0 \\ 0 & {m}_{i 2}\end{matrix} ] [ \begin{matrix}{u}_{i 1} \\ {u}_{i 2}\end{matrix} ] + [ \begin{matrix}{δ}_{i 1} \\ {δ}_{i 2}\end{matrix} ] \qquad ( 106 )$$

where

$${h}_{l 1} = 2 {p}_{i 1}^{2} + {v}_{i 1} cos ( {p}_{i 1} ) , {h}_{i 2} = 2 {p}_{i 2}^{2} + {v}_{i 2} cos ( {p}_{i 2} ) , {g}_{i 1} = sin ( 2 {v}_{i 1} ) ,$$

$${g}_{i 2} = sin ( 2 {v}_{i 2} ) , {Φ}_{i 1} ( t ) = 0.12 sin ( t ) , and {Φ}_{i 2} ( t ) = 0.11 cos ( t ) ,$$

the loss of effectiveness faults are given by mᵢ₁=0.9, mᵢ₂=0.8, the bias faults are given by δᵢ₁=0.1 sin (2t)exp(−0.67t), δᵢ₂=0.1 cos (2t)exp(−0.02t).

The compromised sensor signals of the followers are given as:

$$\{ \begin{matrix}{\overline{p}}_{i} = {Λ}_{{p}_{i}} {p}_{i} \\ {\overline{v}}_{i} = {Λ}_{{v}_{i}} {v}_{i}\end{matrix} , i = {N}_{l} + 1 , … , {N}_{l} + {N}_{f} \qquad ( 107 )$$

where Λₚ_{ᵢ}=1−cos²(t) and Λᵥ_{ᵢ}=1+sin (−3.46t).

The prescribed performance function is designed as:

$${ζ}_{i} ( t ) = \{ \begin{matrix}2 , & t = {t}_{n} \\ ( 2 - 0.2 ) exp ( \frac{- 4 ( t - {t}_{n} )}{1} ) + 0.2 & 0 < t - {t}_{n} < 1 \\ 0.2 , & t - {t}_{n} \geq 1\end{matrix}$$

where ζᵢ₍₀₎=2, ζ_{i∞}=0.2κᵢ=4, Tₛ=1 s, and tₙ=10,12,17,23,29,31, and 33 s.
   Whenever t=tₙ, the prescribed performance function reset to ζᵢ(t)=2.

The stress matrix is computed using the approach as follows:

$$\overline{Ω} = [ \begin{matrix}0.2878 & - 0.2878 & - 0.2878 & 0.1439 & 0.1439 & 0 & 0 \\ - 0.2878 & 0.7194 & 0 & - 0.5756 & 0 & 0 & 0.1439 \\ - 0.2878 & 0 & 0.7194 & 0 & - 0.5756 & 0.1439 & 0 \\ 0.1439 & - 0.5756 & 0 & 0.7194 & - 0.0719 & - 0.2878 & 0 \\ 0.1439 & 0 & - 0.5756 & - 0.0719 & 0.7194 & 0 & - 0.2878 \\ 0 & 0 & 0.1439 & - 0.2878 & 0 & 0.2878 & - 0.1439 \\ 0 & 0.1439 & 0 & 0 & - 0.2878 & - 0.1439 & 0.2878\end{matrix} ]$$

A Gaussian function is chosen as the activation function of the radial basis function neural network. Each of the identifier, actor, and critic neural networks contains five nodes. The centers of the identifier, actor, and critic neural networks are equally spaced within [−33], [−55], and [−55], respectively. The widths of the identifier, actor, and critic neural networks are 1.5, 2.5, and 2.5, respectively. The initial weights of the identifier, actor, and critic neural networks are chosen as Ŵ_{iγ}(0)=0.1_{5×1}&Ŵ_{iF}(0)=0.1_{5×1}, Ŵᵢₐ_{ₚ}(0)=0.2_{5×1}&Ŵᵢₐ_{ᵥ}(0)=0.2_{5×1}, and Ŵ_{ic}_{ₚ}(0)=0.1_{5×1}&Ŵ_{ic}_{ᵥ}(0)=0.1_{5×1}, respectively. The initial positions of the leaders and the followers are set as q₁(0)=[4 0]^{T}, q₂(0)=[2 1]^{T} and q₃(0)=[2 −1]^{T}, q₄(0)=[0.5 1.5]^{T}, q₅(0)=[0.5 −0.5]^{T}, q₆(0)=[−1.75 0.75]^{T}, q₇(0)=[−2 −2.4]^{T}, respectively, with q(0)=[q₁(0)^{T}, q₂(0)^{T}, . . . , q₇(0)^{T}]^{T}=[q₁(0)^{T}q_{f}(0)^{T}]^{T}.

The parameters of the optimized virtual and real controllers are given as

$${K}_{p} = {30}_{8 \times 8} , {C}_{v} = 2 {2}_{8 \times 8} , {K}_{v} = 4 {1}_{8 \times 8} , {Γ}_{ϒ} = {Γ}_{F} = {2}_{8 \times 8} , {σ}_{p} = {σ}_{v} = 0.3 ,$$

$${γ}_{{a}_{p}} = {γ}_{{a}_{v}} = 0.5 , {γ}_{{c}_{p}} = {γ}_{{c}_{v}} = 0.8$$

The simulation results are illustrated with reference to subsequent figures.

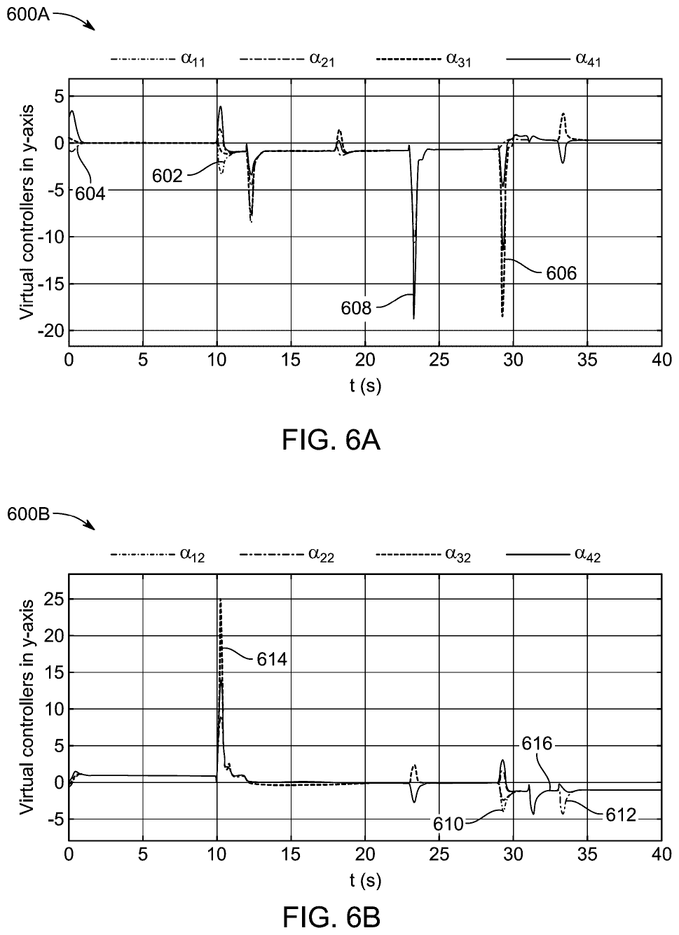

FIG. 6A depicts a behavior 600A of the optimized virtual controllers in the x-axis for the four followers over time, as indicated on the x-axis, measured in seconds (t), while the y-axis represents the values of the virtual controllers in arbitrary units.

Curve 602 illustrates the initial response of the virtual controller for the first follower. It shows that the virtual controller experiences minor oscillations before stabilizing around t=5 seconds. Curve 602 reflects how a virtual controller of the first follower effectively suppresses the disturbances and maintains stability. Curve 604 represents a virtual controller the second follower, which follows a similar pattern to curve 602. After initial fluctuations, a virtual controller of the second follower stabilizes and remains steady for the remainder of the time period. Curve 606 demonstrates the virtual controller for the third follower. Curve 606 shows a series of transient states before the controller achieves stability after t=10 seconds, indicating the robustness of the system in handling fluctuations. Curve 608 depicts a virtual controller of the fourth follower, which also encounters initial disturbances but stabilizes shortly thereafter, demonstrating the efficiency of the proposed control mechanism in mitigating transient disturbances.

FIG. 6B shows a graph 600B of the optimized virtual controllers in the y-axis for the four followers over time, with the x-axis denoting time (t) in seconds and the y-axis indicating the values of the virtual controllers in arbitrary units.

Curve 610 illustrates the virtual controller for the first follower, demonstrating minor oscillations before reaching stability around t=5 seconds, indicating the controller's effective performance in the y-axis. Curve 612 represents the second follower's virtual controller, stabilizing after a similar period of transient disturbances as seen in curve 610. The virtual controller settles into a steady state, showing the system ability to handle initial fluctuations. Curve 614 tracks the virtual controller for the third follower, which exhibits larger oscillations but stabilizes after approximately 10 seconds. Curve 614 shows resilience of the controller in the y-axis under the influence of disturbances. Curve 616 depicts a virtual controller of the fourth follower in the y-axis, showing that, despite transient fluctuations, the controller stabilizes after a brief period, mirroring the patterns seen in the other followers.

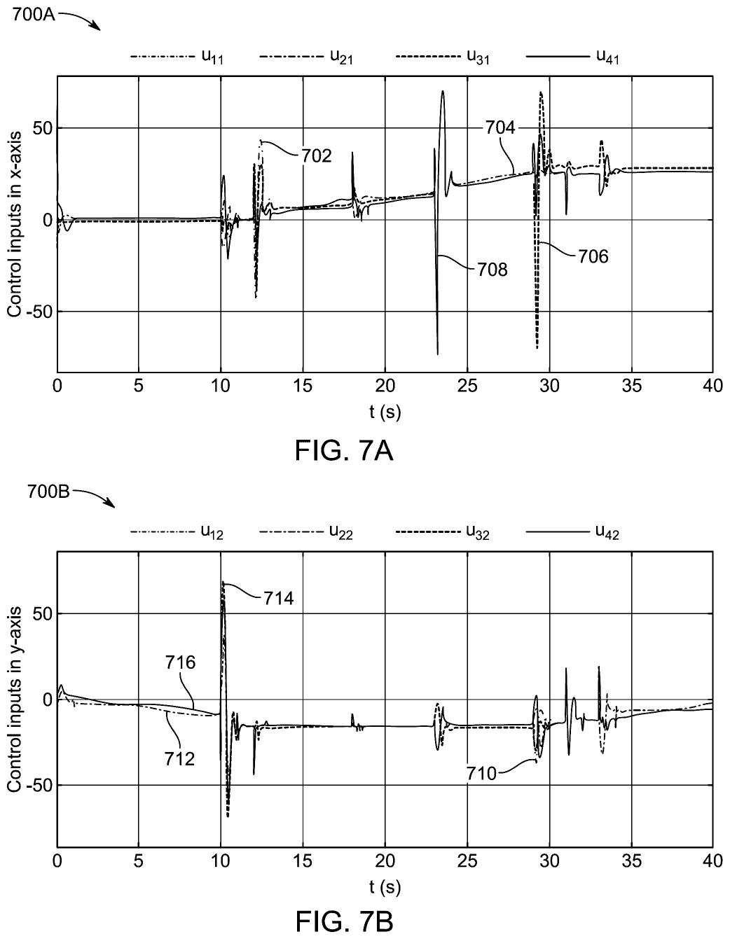

FIG. 7A presents a graph 700A showing the control inputs in the x-axis for the four followers over time, with the x-axis indicating time (t) in seconds and the y-axis showing the control input values in arbitrary units.

Curve 702 represents a control input of the first follower in the x-axis. The curve indicates a rapid correction after the initial disturbance, achieving stability around t=5 seconds and showing effective control input handling. Curve 704 tracks a control input of the second follower, which follows a similar trend as curve 702, stabilizing after initial fluctuations and demonstrating the efficiency of the control system. Curve 706 represents a control input of the third follower, showing significant disturbances between t=20 seconds and t=30 seconds, but eventually stabilizing, indicating how the control input corrects for larger fluctuations. Curve 708 depicts a control input the fourth follower, which follows a similar pattern of early disturbances and subsequent stabilization, reinforcing an ability of the system to manage control inputs effectively.

FIG. 7B illustrates a graph 700B the control inputs in the y-axis for the four followers, with the x-axis representing time (t) in seconds and the y-axis showing the control input values in arbitrary units. The control inputs in the y-axis are represented by curve 710, curve 712, curve 714, and curve 716.

Curve 710 shows a control input of the first follower in the y-axis, stabilizing quickly after initial disturbances around t=5 seconds, indicating robustness of the system in the y-axis. Curve 712 represents a control input of the second follower in the y-axis, following a similar pattern of stabilization after early fluctuations, confirming the effectiveness of the control mechanism. Curve 714 tracks a control input of the third follower, which experiences larger fluctuations but stabilizes over time, demonstrating an ability of the system to correct significant disturbances. Curve 716 reflects a control input of the effectiveness of fourth follower, following the pattern of initial disturbances followed by stabilization, showing the control input across multiple agents.

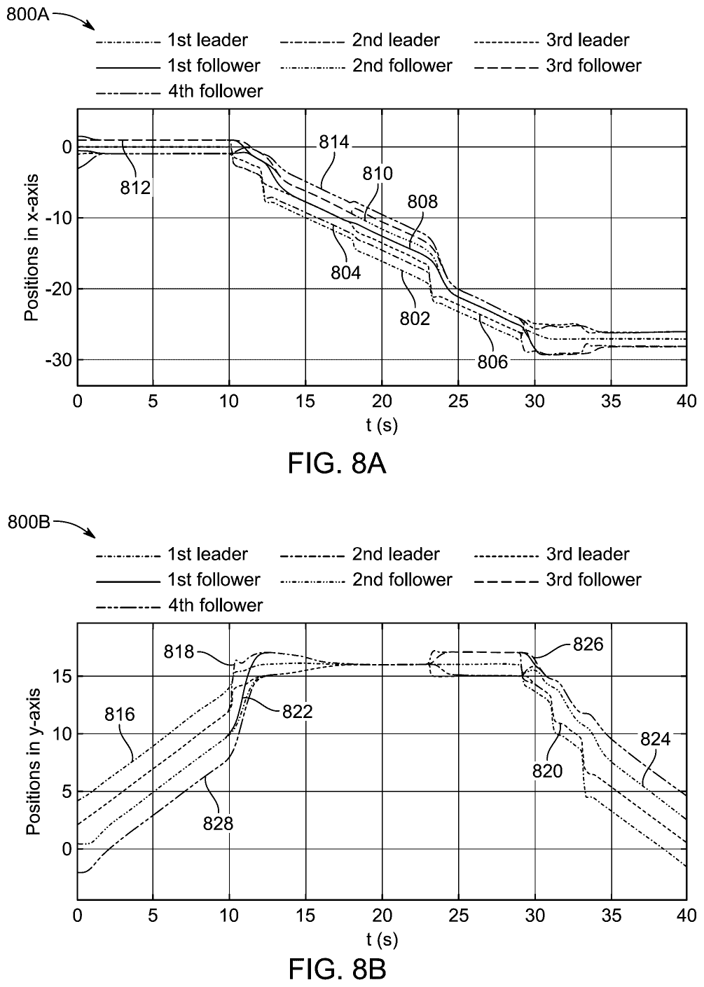

FIG. 8A illustrates a graph 800A the time-varying trajectories of the three leaders and four followers in the x-axis, with the x-axis representing time (t) in seconds and the y-axis representing the positions of the agents in the x-axis in meters.

Curve 802 represents a trajectory of the first leader, showing smooth transitions after initial disturbances and tracking a stable path. Curve 804 represents a trajectory of the second leader, which closely follows a path of the first leader, showing minor deviations but maintaining stability. Curve 806 depicts a trajectory of the third leader, which also stabilizes after initial fluctuations, maintaining a formation of the leader. Curve 808 tracks a trajectory of the first follower, demonstrating effective tracking of the leaders, with only minor deviations corrected over time.

Curve 810 represents a trajectory of the second follower, showing similar tracking performance with stable behavior after early disturbances. Curve 812 shows a trajectory of the third follower, which mirrors the performance of the other followers, stabilizing quickly after initial fluctuations. Curve 814 reflects a trajectory of the fourth follower, demonstrating consistent tracking of the leaders with minor deviations corrected smoothly.

FIG. 8B presents the time-varying trajectories 800B of the leaders and followers in the y-axis, with the x-axis representing time (t) in seconds and the y-axis indicating the positions of the agents in the y-axis in meters.

Curve 816 shows a trajectory of the first leader in the y-axis, indicating smooth transitions after initial disturbances, following a stable path. Curve 818 represents a trajectory of the second leader, which follows a similar pattern of stability after early fluctuations. Curve 820 depicts a trajectory of the third leader, which stabilizes after early disturbances, maintaining alignment with the other leaders. Curve 822 represents a trajectory of the first follower, demonstrating effective tracking of the leaders with minor deviations that are corrected over time. Curve 824 tracks a trajectory of the second follower, showing similar tracking performance and stability after initial disturbances. Curve 826 reflects a trajectory of the third follower, which quickly stabilizes after minor deviations. Curve 828 demonstrates a trajectory of the fourth follower, showing consistent tracking of the leaders with small corrections.

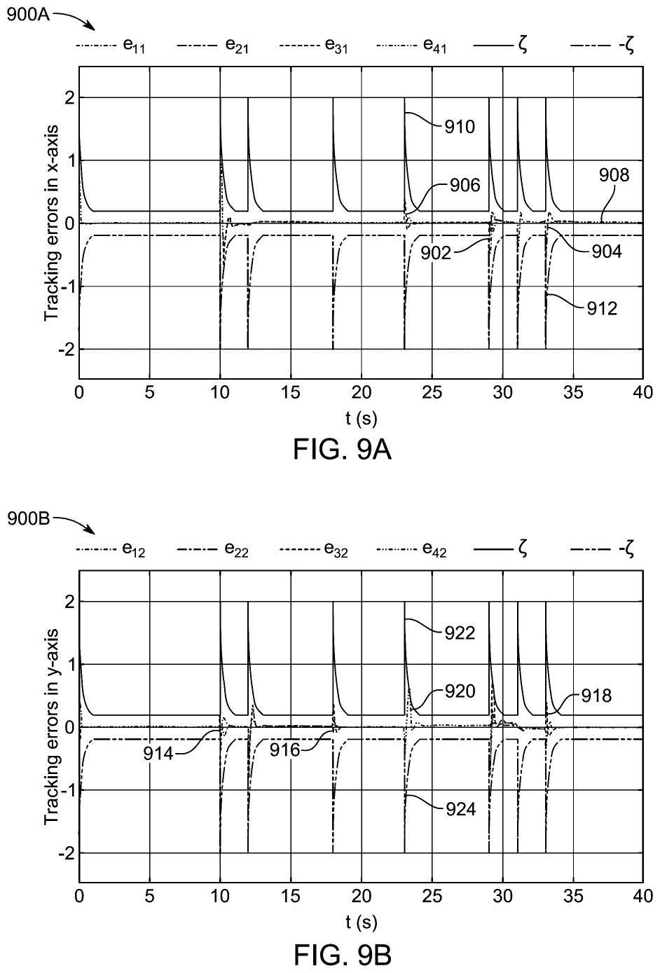

FIG. 9A depicts a graph 900A the tracking errors of the leaders and followers in the x-axis over time. The x-axis represents time (t) in seconds, and the y-axis represents the tracking errors in the x-axis in arbitrary units.

Curve 902 represents the tracking error for the first leader. Initially, the system encounters minor fluctuations in tracking, but the tracking error stabilizes after t=10 seconds, indicating efficient control over the x-axis for the first leader. Curve 904 shows the tracking error for the second leader. Similar to curve 902, a tracking error of the second leader experiences slight disturbances, followed by stabilization, showing ability of the system to mitigate transient states in the x-axis.

Curve 906 represents a tracking error of the third leader. After experiencing more significant deviations around t=20 seconds, the tracking error stabilizes as the system adjusts to maneuvers of the leader. Curve 908 represents the first follower's tracking error in the x-axis. The curve reflects slight instability before achieving a steady state after t=15 seconds, demonstrating effective control over a position of the first follower. Curve 910 shows the tracking error for the second follower. The system corrects significant deviations in a trajectory of the second follower, stabilizing the error around t=25 seconds. Curve 912 depicts a tracking error of the third follower, which undergoes transient fluctuations before stabilizing after t=30 seconds, showing the system's success in managing the tracking errors of the followers.

FIG. 9B illustrates a graph 900B the tracking errors of the leaders and followers in the y-axis over time. The x-axis represents time (t) in seconds, and the y-axis represents the tracking errors in the y-axis in arbitrary units. The performance is represented by curve 914, curve 916, curve 918, curve 920, curve 922, and curve 924. Curve 914 reflects the tracking error for the first leader in the y-axis, demonstrating slight disturbances at the beginning but stabilizing after t=5 seconds as the system maintains control. Curve 916 represents the second leader's tracking error in the y-axis, which initially shows minor deviations but stabilizes quickly after t=10 seconds, indicating robust performance in tracking.

Curve 918 represents the third leader's tracking error, which experiences fluctuations around t=15 seconds but stabilizes over time, showing the system's ability to manage transient disturbances in the y-axis. Curve 920 depicts the first follower's tracking error, showing initial oscillations before stabilizing around t=20 seconds, reflecting the system's control over the y-axis for the first follower. Curve 922 tracks the second follower's tracking error in the y-axis, showing more substantial deviations but eventually stabilizing after t=25 seconds, indicating the system's capacity to correct errors. Curve 924 represents the third follower's tracking error, stabilizing after t=30 seconds, demonstrating that the system effectively manages transient errors in the y-axis.

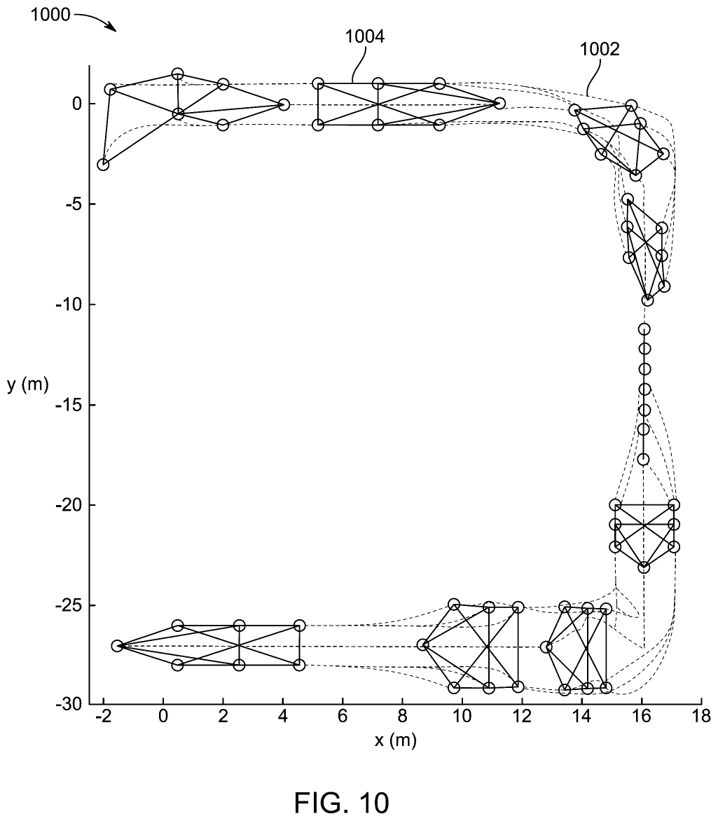

FIG. 10 illustrates an affine formation maneuvers 1000 of the leader-follower system under adversarial conditions. The x-axis represents the position in meters, and the y-axis represents the position in meters. The performance of the leader-follower system during affine formation maneuvers is depicted through curve 1002 and curve 1004.

Curve 1002 represents the trajectories of the leader agents during the affine formation maneuvers. Curve 1002 shows that despite the presence of external disturbances, such as deception attacks and actuator faults, the leaders maintain their predefined formation shape, indicated by the consistent path shown in the graph. Curve 1004 illustrates the trajectories of the follower agents. While the followers experience slight deviations, particularly when subjected to actuator faults and deception attacks, curve 1004 shows that the system's control strategy enables the followers to track the leaders effectively, maintaining the desired formation shape.

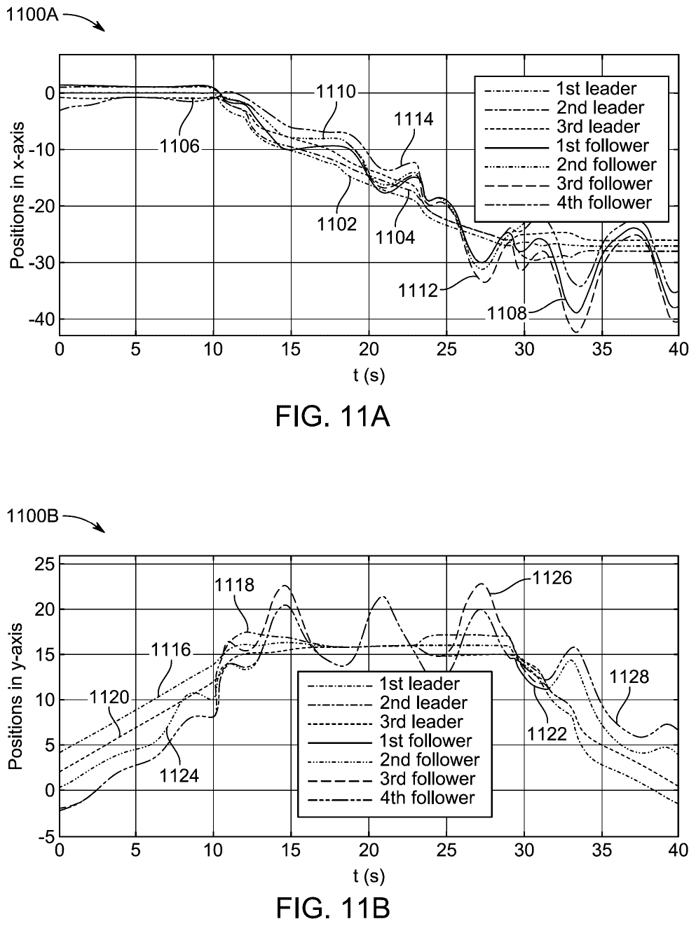

FIG. 11A presents the time-varying trajectories 1100A of the leaders and followers in the x-axis, with the x-axis representing time (t) in seconds and the y-axis representing the positions of the agents in the x-axis in meters.

Curve 1102 depicts the first leader's trajectory in the x-axis. The curve shows a smooth decline over time, indicating controlled movements of the leader along the x-axis as the system maintains stability. Curve 1104 represents a trajectory of the second leader, which follows a similar path to the first leader, demonstrating coordinated control between the leaders in the x-axis. Curve 1106 illustrates a trajectory of the third leader. The curve reflects consistent tracking of the formation maneuver, with minor deviations corrected over time. Curve 1108 represents a trajectory of the first follower, demonstrating effective tracking of the leaders and maintaining proximity to the predefined formation. Curve 1110 shows a trajectory of the second follower, which aligns closely with the other followers, indicating effective control. Curve 1112 represents a trajectory of the third follower, which also follows a stable path after initial deviations. Curve 1114 depicts a trajectory of the fourth follower, which maintains consistent tracking of the leaders with minor adjustments over time.

FIG. 11B presents the time-varying trajectories 1100AB of the leaders and followers in the y-axis, with the x-axis representing time (t) in seconds and the y-axis indicating the positions of the agents in the y-axis in meters. Curve 1116 represents a trajectory of the first leader in the y-axis. The curve reflects smooth transitions with minor disturbances corrected quickly, a position of maintaining the leader. Curve 1118 shows a trajectory the second leader, which closely follows a path of the first leader, demonstrating coordinated movement along the y-axis. Curve 1120 depicts a trajectory of the third leader, which follows a similar stable path as the other leaders. Curve 1122 represents a trajectory of the first follower, maintaining alignment with the leaders and showing effective tracking despite minor deviations. Curve 1124 illustrates a trajectory the second follower, which demonstrates consistent tracking of the leaders with slight corrections. Curve 1126 shows a trajectory of the third follower which stabilizes after initial disturbances, indicating effective control in the y-axis. Curve 1128 depicts the fourth follower's trajectory, following the leaders closely and maintaining the required formation.

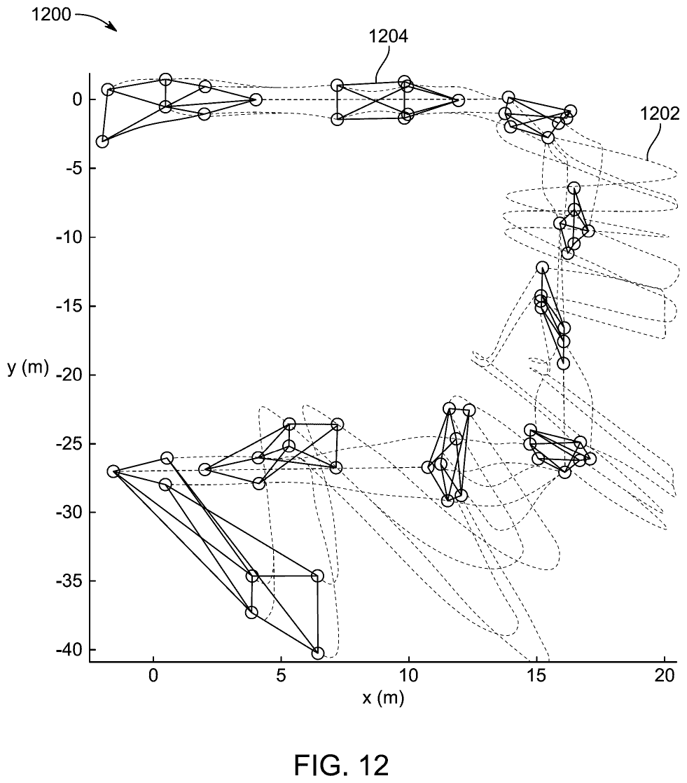

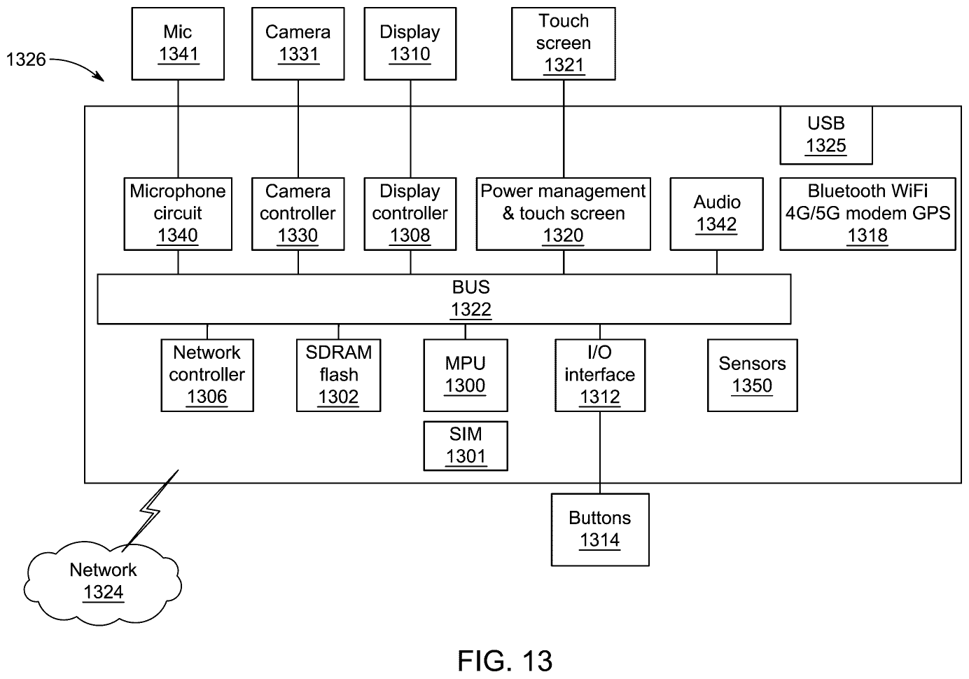

FIG. 12 shows affine formation maneuvers 1200 of the leader-follower system with another existing control method. The x-axis represents the position in meters, and the y-axis represents the position in meters. Curve 1202 represents the trajectories of the leader agents using the previous control method. Curve 1202 indicates that the leaders could not maintain the desired formation under external disturbances such as actuator faults and deception attacks. The instability in the formation is evident from the deviations in the path. Curve 1204 represents the trajectories of the follower agents. Curve 1204 shows the inability of the previous control method to prevent the followers from diverging from their assigned positions. The followers fail to maintain the desired formation and exhibit substantial deviations, reinforcing the limitations of the prior art in handling external disturbances effectively.

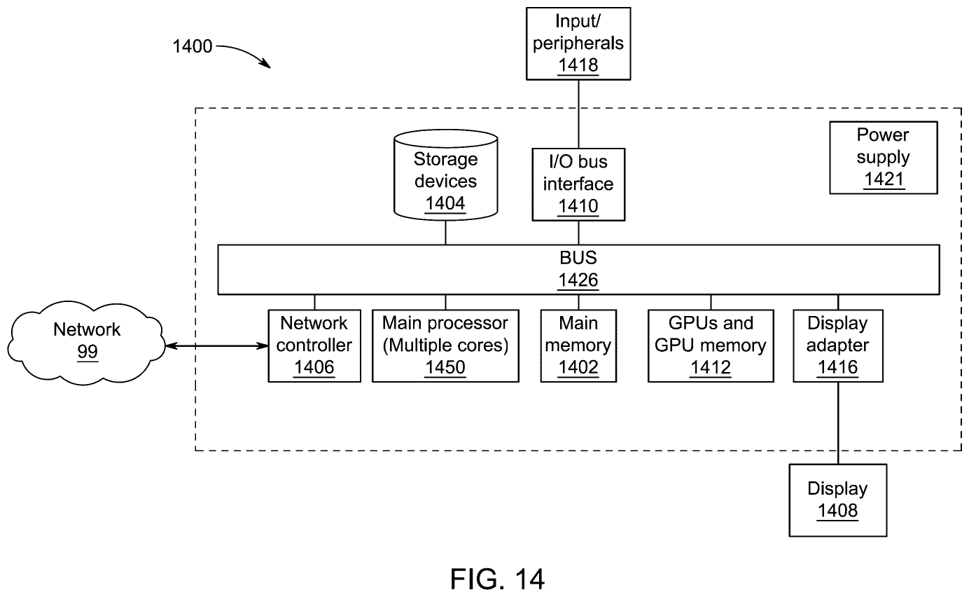

FIG. 13 depicts a hardware description of the processing circuit 1326 according to exemplary embodiments. In one implementation, the functions and processes of the mobile device 130 may be implemented by one or more respective processing circuits 1326. A processing circuit includes a programmed processor as a processor includes circuitry. A processing circuit may also include devices such as an application-specific integrated circuit (ASIC) and conventional circuit components arranged to perform the recited functions. Note that circuitry refers to a circuit or system of circuits. Herein, the circuitry may be in one computer system (as illustrated in FIGS. 13 and 14) or may be distributed throughout a network of computer systems. Hence, the circuitry of the server computer system 120, for example, may be in only one server or distributed among different servers/computers.

In FIG. 13, the processing circuit 1326 includes a Mobile Processing Unit (MPU) 1300 which performs the processes described herein. The process data and instructions may be stored in memory 1302. These processes and instructions may also be stored on a portable storage medium or may be stored remotely. The processing circuit 1326 may have a replaceable Subscriber Identity Module (SIM) 1301 that contains information that is unique to the network service of the mobile device 130.

Further, the claimed advancements are not limited by the form of the computer-readable media on which the instructions of the inventive process are stored. For example, the instructions may be stored in FLASH memory, Secure Digital Random Access Memory (SDRAM), Random Access Memory (RAM), Read Only Memory (ROM), Programmable Read-Only Memory (PROM), Erasable Programmable Read-Only Memory (EPROM), Electrically Erasable Programmable Read-Only Memory (EEPROM), solid-state hard disk or any other information processing device with which the processing circuit 1326 communicates, such as a server or computer.

Further, the claimed advancements may be provided as a utility application, background daemon, or component of an operating system, or combination thereof, executing in conjunction with MPU 1300 and a mobile operating system such as Android, Microsoft® Windows® 10 Mobile, Apple iOS® and other systems known to those skilled in the art.

In order to achieve the processing circuit 1326, the hardware elements may be realized by various circuitry elements, known to those skilled in the art. For example, MPU 1300 may be a Qualcomm mobile processor, a Nvidia mobile processor, an Atom® processor from Intel Corporation of America, a Samsung mobile processor, or an Apple A7 mobile processor, or may be other processor types that would be recognized by one of ordinary skill in the art. Alternatively, the MPU 1300 may be implemented on a Field-Programmable Gate Array (FPGA), Application Specific Integrated Circuit (ASIC), Programmable Logic Device (PLD) or using discrete logic circuits, as one of ordinary skill in the art would recognize. Further, MPU 1300 may be implemented as multiple processors cooperatively working in parallel to perform the instructions of the inventive processes described above.

The processing circuit 1326 in FIG. 13 also includes a network controller 1306, such as an Intel Ethernet PRO network interface card from Intel Corporation of America, for interfacing with network 1324. As can be appreciated, the network 1324 can be a public network, such as the Internet, or a private network such as LAN or WAN network, or any combination thereof and can also include PSTN or ISDN sub-networks. The network 1324 can also be wired, such as an Ethernet network. The processing circuit may include various types of communications processors for wireless communications including 3G, 4G, and 5G wireless modems, WiFi®, Bluetooth®, GPS, or any other wireless form of communication that is known.

The processing circuit 1326 includes a Universal Serial Bus (USB) controller 1325 which may be managed by the MPU 1300.

The processing circuit 1326 further includes a display controller 1308, such as a NVIDIA® GeForce® GTX or Quadro® graphics adaptor from NVIDIA Corporation of America for interfacing with display 1310. An I/O interface 1312 interfaces with buttons 1314, such as for volume control. In addition to the I/O interface 1312 and the display 1310, the processing circuit 1326 may further include a microphone 1341 and one or more cameras 1331. The microphone 1341 may have associated circuitry 1340 for processing the sound into digital signals. Similarly, the camera 1331 may include a camera controller 1330 for controlling image capture operation of the camera 1331. In an exemplary aspect, the camera 1331 may include a Charge Coupled Device (CCD). The processing circuit 1326 may include an audio circuit 1342 for generating sound output signals and may include an optional sound output port.

The power management and touch screen controller 1320 manage power used by the processing circuit 1326 and touch control. The communication bus 1322, which may be an Industry Standard Architecture (ISA), Extended Industry Standard Architecture (EISA), Video Electronics Standards Association (VESA), Peripheral Component Interface (PCI), or similar, for interconnecting all of the components of the processing circuit 1326. A description of the general features and functionality of the display 1310, buttons 1314, as well as the display controller 1308, power management controller 1320, network controller 1306, and I/O interface 1312 is omitted herein for brevity as these features are known.

FIG. 14 is a block diagram illustrating an example computer system for implementing the machine learning training and inference methods according to an exemplary aspect of the disclosure. The computer system may be an AI workstation running an operating system, for example Ubuntu Linux OS, Windows, a version of Unix OS, or Mac OS. The computer system 1400 may include one or more central processing units (CPU) 1450 having multiple cores. The computer system 1400 may include a graphics board 1412 having multiple GPUs, each GPU having GPU memory. The graphics board 1412 may perform many of the mathematical operations of the disclosed machine learning methods. The computer system 1400 includes main memory 1402, typically random access memory RAM, which contains the software being executed by the processing cores 1450 and GPUs 1412, as well as a non-volatile storage device 1404 for storing data and the software programs. Several interfaces for interacting with the computer system 1400 may be provided, including an I/O Bus Interface 1410, Input/Peripherals 1418 such as a keyboard, touch pad, mouse, Display Adapter 1416 and one or more Displays 1408, and a Network Controller 1406 to enable wired or wireless communication through a network 99. The interfaces, memory and processors may communicate over the system bus 1426. The computer system 1400 includes a power supply 1421, which may be a redundant power supply.

In some embodiments, the computer system 1400 may include a server CPU and a graphics card by NVIDIA, in which the GPUs have multiple CUDA cores. In some embodiments, the computer system 1400 may include a machine learning engine 1412.

The present disclosure introduces an optimized, secure, fault-tolerant control strategy with prescribed performance for affine formation maneuvers in nonlinear, second-order, leader-follower multi-agent systems subject to actuator faults and deception attacks. A novel prescribed performance function is proposed, characterized by a preassigned convergence time, capable of resetting whenever the target formation maneuver alters, thereby maintaining the new transient states of leader-follower tracking errors within predefined bounds. Subsequently, an optimized backstepping control approach is developed for the system, leveraging a streamlined identifier-actor-critic reinforcement learning framework. Within this scheme, the identifier network estimates the system's nonlinear dynamics, the actor network executes the control actions, and the critic network evaluates the control performance.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A system for controlling a trajectory of coordinated time-varying maneuvers of a geometric formation of unmanned vehicles, the system comprising:
a plurality of the unmanned vehicles, each having
communication circuitry configured to communicate between each unmanned vehicle of the plurality of the unmanned vehicles, wherein a subset of the plurality of the unmanned vehicles are leader vehicles and remaining unmanned vehicles are follower vehicles, for leader-follower maneuvering of the geometric formation of the plurality of unmanned vehicles to target positions of the trajectory;
an actuator suite to maintain and adjust direction and orientation of a respective unmanned vehicle,
a sensor suite to stabilize and navigate the respective unmanned vehicle,
a flight controller configured to send a control signal to the actuator suite and receive a feedback signal from the sensor suite, wherein the flight controller maintains stable maneuvering of the respective unmanned vehicle while the actuator suite is subject to an actuator fault and the sensor suite is subject to a deception attack; and
processing circuitry configured to control the leader-follower maneuvering of the geometric formation of the plurality of unmanned vehicles,
wherein the maneuvering of the plurality of unmanned vehicles is controlled with a reinforcement learning neural network that includes
an identifier radial basis function neural network to estimate nonlinear movement of the plurality of unmanned vehicles,
an actor radial basis function neural network to adjust direction and orientation of the respective unmanned vehicle by the respective actuator suite based on the estimated nonlinear movement, and
a critic radial basis function neural network to assess the adjusted direction and orientation of each of the unmanned vehicles based on a feedback signal by the sensor suite,
wherein the feedback signal includes corrupted signals from the sensor suite due to the deception attack.

2. The system of claim 1, wherein the processing circuitry is further configured to train the reinforcement learning neural network to learn a performance function that resets a preassigned convergence time whenever a target formation maneuver changes to maintain transient states of each leader-follower tracking error within a predefined range.

3. The system of claim 2, wherein the processing circuitry is further configured to control the leader vehicles to maneuver in a coordinated time-varying formation including one or more of shape, direction, rotation, scaling, and translation,
wherein the follower vehicles track positions of the leader vehicles to achieve the target formation maneuver.

4. The system of claim 1, wherein the communication circuitry uses WiFi for communication with others of the plurality of unmanned vehicles.

5. The system of claim 2, wherein the processing circuitry is further configured for controlling the leader-follower maneuvering in an affine formation of the plurality of unmanned vehicles.

6. The system of claim 5, wherein the processing circuitry is further configured to train the reinforcement learning neural network to learn the performance function using performance-constrained backstepping control,
wherein an initial control by the reinforcement learning neural network is used as an intermediate control input, and
wherein optimal laws for the backstepping control are obtained from an approximate solution of a Hamilton-Jacobi-Bellman equation using the reinforcement learning.

7. The system of claim 1, wherein the plurality of the unmanned vehicles are unmanned aerial vehicles, each having a plurality of top-mounted rotors to move the unmanned aerial vehicle forward, backward, left, and right by adjusting speed of each rotor,
wherein the plurality of top-mounted rotors are driven by the actuator suite.

8. The system of claim 1, wherein the plurality of unmanned vehicles are unmanned aerial vehicles, each having a single rotor and a plurality of movable fins,
wherein the single rotor and the plurality of movable fins are driven by the actuator suite.

9. The system of claim 1, further comprising a ground-based controller configured with the processing circuitry, for centralized control of the leader-follower maneuvering of the geometric formation.

10. The system of claim 1, wherein the flight controller of each of the unmanned vehicles executes program instructions to obtain sensor suite data and adjust the unmanned vehicle positioning and rotor speeds based on the sensor suite data.

11. The system of claim 1, wherein the sensor suite in each of the plurality of unmanned vehicles includes a gyroscope, an accelerometer, and magnetometer.

12. The system of claim 1, wherein the sensor suit in the leader vehicles includes one or more sensors for detection of obstacles.

13. A non-transitory computer-readable storage medium including computer executable instructions, wherein the instructions, when executed by a computer, cause the computer to perform a method for controlling a trajectory of coordinated time-varying maneuvers of a geometric formation of unmanned vehicles, the method comprising:
controlling a leader-follower maneuvering of the geometric formation of a plurality of unmanned vehicles with a reinforcement learning neural network, wherein a subset of the unmanned vehicles are leader vehicles and remaining unmanned vehicles are follower vehicles, for the leader-follower maneuvering of the geometric formation of the plurality of unmanned vehicles to target positions of a trajectory, including
estimating, by an identifier radial basis function neural network, nonlinear movement of the plurality of unmanned vehicles,
adjusting, by an actor radial basis function neural network, direction and orientation of the respective unmanned vehicle by actions that control a respective actuator suite based on the estimated nonlinear movement, wherein the actuator suite is subject to an actuator fault, and
assessing, by a critic radial basis function neural network, the adjusted direction and orientation of each of the unmanned vehicles based on a feedback signal from a sensor suite,
wherein the feedback signal includes corrupted signals from the sensor suite due to a deception attack.

14. The computer-readable storage medium of claim 13, further comprising resetting, by a performance function, a preassigned convergence time whenever a target formation maneuver changes to maintain transient states of each leader-follower tracking error within a predefined range.

15. The computer-readable storage medium of claim 14, further comprising:
controlling the leader vehicles to maneuver in a coordinated time-varying formation including one or more of shape, direction, rotation, scaling, and translation; and
controlling the follower vehicles to track positions of the leader vehicles to achieve the target formation maneuver.

16. The computer-readable storage medium of claim 14, further comprising controlling the leader-follower maneuvering in an affine formation of the plurality of unmanned vehicles.

17. The computer-readable storage medium of claim 14, further comprising:
executing the performance function using performance-constrained backstepping control,
wherein an initial control by the reinforcement learning neural network is used as an intermediate control input, and
wherein optimal laws for the backstepping control are obtained from an approximate solution of a Hamilton-Jacobi-Bellman equation using the reinforcement learning.

18. A method for controlling a trajectory of coordinated time-varying maneuvers of a geometric formation of unmanned vehicles, the method comprising:
controlling a leader-follower maneuvering of the geometric formation of a plurality of unmanned vehicles with a reinforcement learning neural network, wherein a subset of the unmanned vehicles are leader vehicles and remaining unmanned vehicles are follower vehicles, for the leader-follower maneuvering of the geometric formation of the plurality of unmanned vehicles to target positions of a trajectory, including
estimating, by an identifier radial basis function neural network, nonlinear movement of the plurality of unmanned vehicles,
adjusting, by an actor radial basis function neural network, direction and orientation of the respective unmanned vehicle by actions that control a respective actuator suite based on the estimated nonlinear movement, wherein the actuator suite is subject to an actuator fault, and
assessing, by a critic radial basis function neural network, the adjusted direction and orientation of each of the unmanned vehicles based on a feedback signal from a sensor suite,
wherein the feedback signal includes corrupted signals from the sensor suite due to a deception attack.

19. The method of claim 18, further comprising resetting, by a performance function, a preassigned convergence time whenever a target formation maneuver changes to maintain transient states of each leader-follower tracking error within a predefined range.

20. The method of claim 19, further comprising:
executing the performance function using performance-constrained backstepping control,
wherein an initial control by the reinforcement learning neural network is used as an intermediate control input, and
wherein optimal laws for the backstepping control are obtained from an approximate solution of a Hamilton-Jacobi-Bellman equation using the reinforcement learning.
